(19) United States
(12) Patent Application Publication
(10) Pub. No.: US 2008/0320594 A1
(43) Pub. Date: Dec. 25, 2008

(54) Malware Detector

(76) Inventor: Xuxian Jiang, Centreville, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/051,703

(22) Filed: Mar. 19, 2008

Related U.S. Application Data
(60) Provisional application No. 60/895,546, filed on Mar. 19, 2007.

(51) Int. Cl. G06F 21/00

(52) U.S. Cl. 726/24

(57) ABSTRACT

The malware detection system enables out-of-the box, tamper-resistant malware detection without losing the semantic view. This system comprises at least one guest operating system and at least one virtual machine, where the guest operating system runs on the virtual machine. Having virtual resources, the virtual machine resides on a host operating system. The virtual resources include virtual memory and at least one virtual disk. A virtual machine examiner is used to examine the virtual machine. With a virtual machine inspector, a guest function extrapolator, and a transparent presenter, the virtual machine examiner resides outside the virtual machine. The virtual machine inspector is configured to retrieve virtual machine internal system states and/or events. The guest function extrapolator is configured to interpret such states and/or events. The transparent presenter is configured to present the interpreted states and/or events to anti-malware software. The anti-malware software is configured to use the interpreted states and/or events to detect any system compromise.

### CROSS REFERENCE TO RELATED APPLICATIONS

The present application claims the benefit of provisional patent application Ser. No. 60/895,546 to Jiang, filed on Mar. 19, 2007, entitled “Malware Detector,” which is hereby incorporated by reference.

### BACKGROUND OF THE INVENTION

Host-based anti-virus software is facing intense competition from emerging stealthy and sophisticated malware. Internal deployment of host-based anti-virus software can provide visibility of the dynamic system state of a machine. Unfortunately, its very internal presence can make itself visible, tangible, and potentially subvertable by advanced malware if present on the system.

In the meantime, internet malware is getting more stealthy and sophisticated. Beyond providing regular malicious functions, such as backdoor access, emerging malware is more intended to accommodate advanced techniques that allow them to avoid detection from commodity anti-virus software. Reports [51, 54] have shown that new computer worms (including botnet-related ones) and viruses deliberately avoid fast massive propagation. They now tend to lurk in infected machines and stealthily inflict contaminations over time based on installed rootkits. Moreover, it is not uncommon that advanced malware has the capability to detect, evade, and subvert current anti-virus software. For example, a detailed analysis of an “in-the-wild” Agobot variant [30] has revealed that it contains malicious logic to detect and remove more than 105 legitimate anti-virus processes, if currently running in the target system.

These real-world threats can significantly weaken the effectiveness and reliability of host-based anti-virus software, which indicate that current models on the deployment and management of host-based anti-virus software may need reconsideration. The current de-facto model appears to be seriously flawed. Host-based anti-virus software installed and running “inside-the-box” may provide needed visibility on a running system. However, it remains vulnerable to advanced malware if also present on the system. Due to software complexities in existing operating systems (OSes) [44], OS-level vulnerabilities may be discovered [39, 59]. The exploitation of these vulnerabilities may directly compromise the kernel integrity. Once the kernel is contaminated (for instance, with the installation of a kernel-level rootkit [33, 47], the effectiveness of these anti-virus software can become seriously questionable [32], no matter how advanced is the anti-virus software.

Consequently, what is needed is a mechanism for operating anti-virus software from outside the operating system that is being monitored for malware.

### BRIEF DESCRIPTION OF THE SEVERAL VIEWS OF THE DRAWINGS

FIG. 1 shows an embodiment of a block diagram of a tangible computer readable medium housing a method for detecting malware on a virtual machine.

FIG. 2 shows another embodiment of a block diagram of a tangible computer readable medium housing a method for detecting malware on a virtual machine.

FIG. 3 shows a block diagram of an exemplified malware detection system with three key techniques behind VMwatcher: nonintrusive virtual machine introspection (VMI), guest function extrapolation, and transparent representation.

FIG. 4 shows a block diagram of an exemplified malware detection apparatus.

FIG. 5 shows another block diagram of an exemplified malware detection system.

FIG. 6 is a block diagram showing a direct kernel object manipulation (DKOM) attack in Linux.

FIG. 7 shows part 1 of a compromised virtual machine honeypot (RedHat 7.2) that is externally examined with Windows File Manager.

FIG. 8 shows part 2 of the compromised virtual machine honeypot (RedHat 7.2) that is externally examined with Windows File Manager.

FIG. 9 shows an internal scan on a Windows XP image (infected by the Hacker Defender or hxdef rootkit).

FIG. 10 shows an external scan on the same Windows XP image (infected by the Hacker Defender or hxdef rootkit).

FIG. 11 shows a VMwarebased Windows XP VM infected by the FU rootkit.

FIG. 12 shows a Xenbased Fedora Core 4 VM infected by the adoring rootkit.

FIG. 13 shows a comparison between an internal scanning time and an external scanning time.

FIG. 14 is a graph showing memory analysis latency.

FIG. 15 shows an incomplete graph of Linux kernel memory management structures: linking together related kernel level data structures.

FIG. 16 shows various separate and individual structures of FIG. 15.

FIG. 17 shows an external inspection of a honeypot with the Symantec AntiVirus software before launching a scanning.

FIG. 18 shows an external inspection of a honeypot with the Symantec AntiVirus software after completing a scanning.

FIG. 19 shows external inspection of the honeypot with Microsoft Windows Defender before launching a scanning.

FIG. 20 shows external inspection of the honeypot with Microsoft Windows Defender after completing a scanning.

FIG. 21 is a list of real-world antivirus software.

### DETAILED DESCRIPTION OF THE INVENTION

Embodiments of the present invention enable “out of the box” malware detection with virtual machines by providing mechanisms for malware detection software running outside of a virtual machine to detect malware infections inside the virtual machine. Throughout this disclosure, embodiments of the present invention are sometimes referred to as VMwatcher.

Deploying anti-virus software “out of the box” (e.g. over a network) has the potential to provide an extra level of integrity and reliability over internally deployed anti-virus software. But, unfortunately, it can be at the cost of significantly reducing its visibility on the internal system state. Limited visibility may prevent anti-virus software from running. Embodiments of the present invention enable the design and implementation of a virtual machine (VM)-based system that essentially solves this challenge. Furthermore, embodiments of the present invention use non-intrusive virtual machine introspection to reliably inspect low-level VM system states. Moreover, a new technique described herein, called “guest function extrapolation” that extracts meaningful semantic-rich information from these low-level system states, is disclosed. The extracted information can then be transparently encapsulated and natively presented to off-the-shelf anti-virus software running outside the VM. Operating embodiment prototypes have been implemented in both Linux and Windows platforms, transparently supporting a wide variety of real-world anti-virus software, such as Symantec AntiVirus, Microsoft Windows Defender, and McAfee VirusScan. These VM watching prototypes may enable external execution of off-the-shelf host-based anti-virus software, while maintaining desirable, internal visibility. Experimental results with real-world malware have successfully shown its practicality and effectiveness. In addition, experiments with prototypes on more than a dozen stealth malware (e.g., kernel-level rootkits) demonstrate the new opportunity enabled by VM watching embodiments in performing live cross-view differential analysis to detect stealth malware.

Embodiments of the present invention use recent advances on virtualization, in particular virtual machines, to address the growing malware problem. A virtual machine may strictly confine any processes running inside the VM. Even if compromised (and/or lead to malicious malware installation), it may be extremely difficult, if not impossible, to affect processes now running outside the VM, a desirable isolation property needed to protect anti-virus software. However, to allow off-the-shelf anti-virus software (e.g., Symantec AntiVirus [46], etc.) that is now running outside a VM to detect possible malware infections inside a VM, various challenges may need to be overcome.

One challenge is external inspection. External inspection allows an external process to examine the system state of a running VM. Current VMs (such as VMware [55] and Xen [3]) are mainly designed to create a confined environment with virtualized physical resources to support commodity OS's and applications. As a side effect, they may enforce mutual-invisibility between internal processes (running inside a VM) and external processes (running outside a VM). External inspection may need to break this barrier unidirectionally by only allowing external inspection on a VM's internal system states (e.g., virtual disks and memory) without perturbing its normal operations.

Another challenge is semantic gap. Most virtual machines encapsulate the whole machine state with all of internally running processes, which can be a useful and desirable property for dynamic resource re-mapping and machine mobility. However, such encapsulation may unintentionally cause significant difficulties. In particular, encapsulation can introduce a large semantic gap between the level of abstraction in which the off-the-shelf anti-virus software would naturally use and the level of abstraction that may be exposed by the VM (through external inspection). For example, a virtual machine monitor can expose the physical memory that is being virtualized and allocated to a VM to an external process. However, interpreting content to identify running processes and loaded kernel modules may require semantic information (such as page tables of running processes and other sensitive kernel-level data structures) of that particular VM. Different guest VM kernels often require different ways to resolve the semantic gaps (e.g. a Windows XP memory image certainly contains different semantic meanings from a Linux memory image), posing additional complexities.

A further challenge can involve transparent support of custom or off-the-shelf anti-virus software. Off-the-shelf anti-virus software tend to have implicit assumptions on their target environments. For example, Tripwire [12] (available from Tripwire, Inc. of Portland, Oreg.), one of the earliest change auditing software, assumes a standard UNIX-like file system layout to calculate the checksums of protected files and directories. As another example, “chkrootkit” [49] (developed mostly at the Univ. of Hamburg) also assumes a UNIX-like /proc file systems to enumerate active processes. These assumptions, which do not necessarily hold true today, are based on the original perception that anti-virus processes, protected files and directories, /proc file system, and malware, if present, are inside the same system. As a result, the information may need to be transparently encapsulated after the resolution of semantic gaps and natively presented to the off-the-shelf anti-virus software for malware detection.

The VMwatcher and embodiments of the present invention address the above challenges using virtual machine introspection (VMI) [7] to monitor low-level VM system states (without perturbing its execution). Semantic gaps may be resolved using a new technique herein called “guest function extrapolation” (also known as “guest view casting”). By extrapolating guest functions, embodiments extract semantic-rich information (e.g., files, directories, processes, and kernel-level modules) from low-level system states, in a similar way how they are interpreted by the VM. The extracted information may then be transparently encapsulated and natively represented, with another technique called transparent representation, to commodity anti-virus software running outside the VM.

Tal Garfinkel and Mendal Rosenblum [7] (hereinafter referred to as “Garfinkel and Rosenblum”) describes a VMI technique in the article “A Virtual Machine Introspection Based Architecture for Intrusion Detection,” published in Proc. of the 2003 Network and Distributed System Security Symposium, February 2003. However, their architecture is intrusive. Unlike Garfinkel and Rosemblum's technique, the present invention implements a non-intrusive VMI that avoids unnecessary perturbations on the examined VM state. Prototypes have been built for four different virtual machine monitors (VMMs): VMware [55] (available from VMware, Inc. of Palo Alto Calif.), QEMU, Xen [3] (available from XenSource, Inc. of Palo Alto Calif.), and User Mode Linux (UML) [5] (open source software available at user-mode-linux.sourceforge.net).

VMware and QEMU are examples of a full virtualization approach. Xen and UML are examples of a para-virtualization approach. Table 1 below lists the VMM level state observations offered by these four examples. The open-source VMMs (QEMU, Xen, and UML) allow full access to low-level VM states and events. The close-source VMware only exposes the raw blocks and raw memory pages allocated to a VM. Embodiments of the VMwatcher generically support various VMMs in both approaches.

TABLE 1
VMM-level VM state observations

| | Full virtualization | | Para-virtualization | |
|---|---|---|---|---|
| VMM-level observation | VMware | QEMU | Xen | UML |
| Raw VM disk image | Yes | Yes | Yes | Yes |
| Raw VM memory image | Yes | Yes | Yes | Yes |
| Other VM hardware states | No | Yes | Yes | Yes |
| (e.g., machine registers) | | | | |
| VM-related low-level events | No | Yes | Yes | Yes |
| (e.g., interrupts/traps) | | | | |

With the development of two additional techniques, namely guest function extrapolation and transparent representation, embodiments may support off-the-shelf anti-virus software. This difference contrasts against VMMs that only supports its own specialized IDS system, such as Livewire (built by Garfinkel and Rosenblum).

The “out of the box” approach also enables unique opportunities in detecting more advanced stealth malware, especially kernel-level rootkits [18, 33, 34, 36, 37, 47]. From an external perspective, this “out of the box” approach provides an unmasked view of current system (e.g., disk files, running processes, loaded kernel modules, etc.), which can then be compared with an internal (possibly contaminated) view of the same system. The comparison essentially enables a new opportunity—a live cross-view differential analysis [25] that is powerful in identifying sophisticated malware.

VMwatcher embodiments have been implemented in both Linux and Windows platforms, transparently supporting a number of real-world anti-virus software (such as Symantec AntiVirus [46], Microsoft Windows Defender [40], McAfee VirusScan [38], Sophos Anti-Virus [45], ClamAV [31], and Tripwire [12]. Experimental results with a variety of real-world malware have successfully demonstrated the practicality and effectiveness of the “out of the box” approach. Furthermore, the experiments with more than a dozen stealth kernel-level rootkits have shown its unique capabilities and applications in detecting these advanced malware.

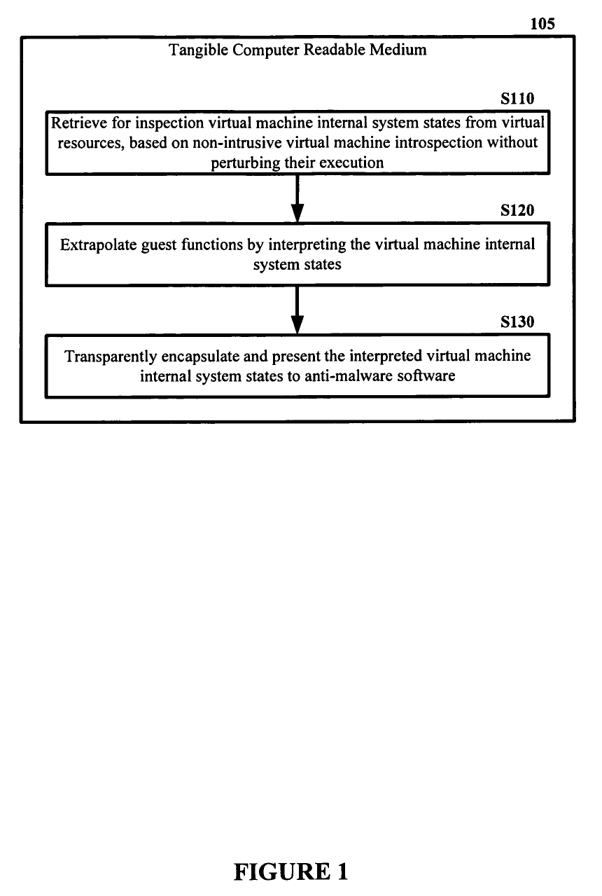

Keeping the above in mind and referring to FIGS. 1-5, the present invention may be embodied in the form of a physical or tangible computer-readable medium (e.g., computer program product, etc.), a system, or an apparatus. In addition, methods of implementing the present invention are also embodied. All of these forms enable tamper-resistant malware detection without losing the semantic view. They incorporate a VMM “out of the box” approach that overcomes a semantic gap challenge.

As a tangible computer readable medium, examples include, but are not limited to, a compact disc (cd), digital versatile disc (dvd), usb flash drive, floppy disk, random access memory (RAM), read-only memory (ROM), erasable programmable read-only memory (EPROM), optical fiber, electronic notepad or notebook, etc. It should be noted that the tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

The instructions may be written using any computer language or format. Nonlimiting examples of computer languages include Ada, Ajax, Basic, C, C++, Cobol, Fortran, Java, Python, XML, etc.

As shown in FIG. 1, the tangible computer readable medium 105 may be encoded with instructions for detecting malware on a virtual machine. The virtual machine may reside on a host operating system. Examples of host operating systems include, but are not limited to, any Windows based platform operating systems (e.g., Vista, XP, 2000, Me, 98, etc.), Linux, etc. Such examples also include all of their editions, versions, service packs, updates, etc.

The instructions for detecting the malware may be executed from outside the virtual machine. Upon execution, one or more processors may retrieve for inspecting virtual machine internal system states from virtual resources S105, extrapolating guest functions by interpreting the virtual machine internal system states S110, and transparently encapsulating and presenting the interpreted machine internal system states to anti-malware software S115.

Inspection may be based on non-intrusive virtual machine introspection without perturbing execution of the virtual machine internal system states. The virtual resources housing such states may include a virtual machine memory and at least one virtual disk. These states may comprise virtual memory states and/or virtual disk states. Each of these types of states may be interpreted to enable guest function extrapolation. Extrapolation generally aids in extracting semantic-rich data (e.g., files, directories, processes, kernel modules, etc.) from the virtual machine internal system states to resolve or minimize semantic gaps. In particular, extrapolating guest functions systematically reconstructs the VM's internal semantic view (e.g., files, directories, processes, kernel-level modules, etc.) for out-of-the-box malware detection. This new technique is based on the key observation that the guest operation system of a VM may provide all necessary semantic definitions of guess data structures and functions to construct the VM's semantic view. As such, they can be casted on VMM-level observations. This unique feature can enable external reconstruction of the semantic view of the target VM. In an embodiment, guest function extrapolation can perform high-fidelity restoration of semantic objects so that the restored objects are presented to the anti-malware software in exactly the same way as inside the VM.

As for the anti-malware software, such software may be configured to use the various interpreted virtual machine internal system states (i.e., interpreted virtual memory states, interpreted virtual disk states) to detect system compromises. Examples of anti-malware software include, but are not limited to, Symantec AntiVirus, Microsoft Windows Defender, McAfee VirusScan, Sophos Anti-Virus, ClamAV, and Tripwire.

It should be noted that not all the instructions need to be executed from outside the virtual machine for the present invention to work. In some instances, at least some of the instructions are executed on the host operating system.

The instructions may further include retrieving virtual network interface states from at least one virtual network interface. The virtual network interface is another type of virtual resource that can be found in the virtual machine. The virtual network interface may serve as an interconnection point or network connection point between at least two components and/or user. Nonlimiting examples of connection points include the user and the VMwatcher, the VM and guest operating system, the VM and host operating system, guest operating system and operating system, VM and VMwatcher, guest operating system and VMwatcher, host operating system and VMwatcher, VM monitor and host operating system, VM monitor and guest operating system, VM and VM monitor, VMwatcher and virtual hardware, VMwatcher and anti-malware software, etc. One skilled in the art would appreciate that this list is not exhaustive and may include other combinations, including more than 2 objects with or without (in conjunction) the user.

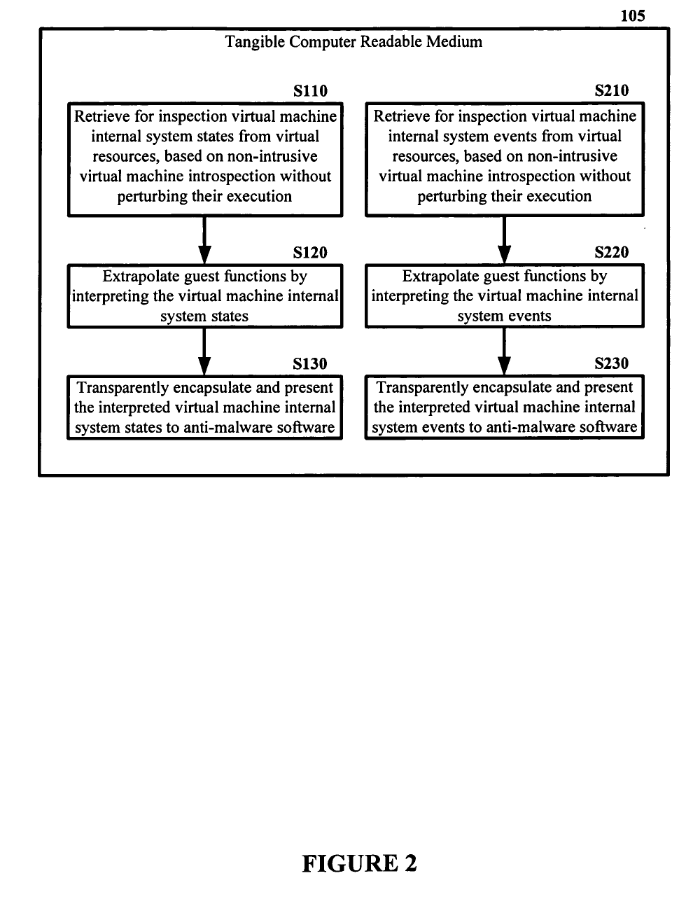

In addition to virtual network interface states, the instructions may further include, as shown in FIG. 2, retrieving for inspection virtual machine internal system events from the virtual resources S210. Retrieval may also be based on non-intrusive virtual machine introspection without perturbing their execution. The retrieval process may be achieved by using instructions executed between the host operating system and the virtual machine. The virtual machine internal system events may comprise virtual memory events and/or virtual disk events.

FIG. 2 also goes on to show that the instructions further include interpreting the virtual memory events and/or virtual disk events S220. After interpretation, the instructions may further include transparently encapsulating and presenting the interpreted virtual memory events and/or the interpreted virtual disk events to the anti-malware software S230.

Interpreting either or both these types of events also help enable guest function extrapolation. Just as with the virtual machine internal system states, extrapolation can aid in extracting semantic-rich data (like the ones above) from the virtual machine internal system events.

All of the embodied instructions for the tangible computer readable medium may be separately and independently embodied as methods (i.e., S110, S120, S130, S210, S220, S230) of detecting malware on a virtual machine. These methods may be incorporated in a malware detection system or apparatus.

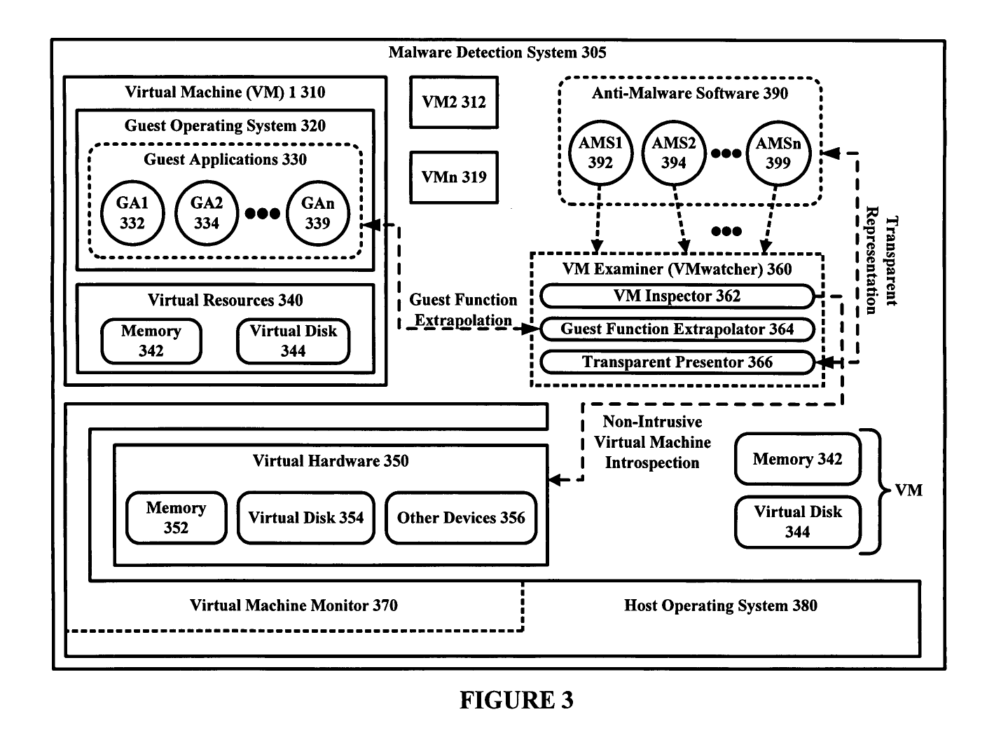

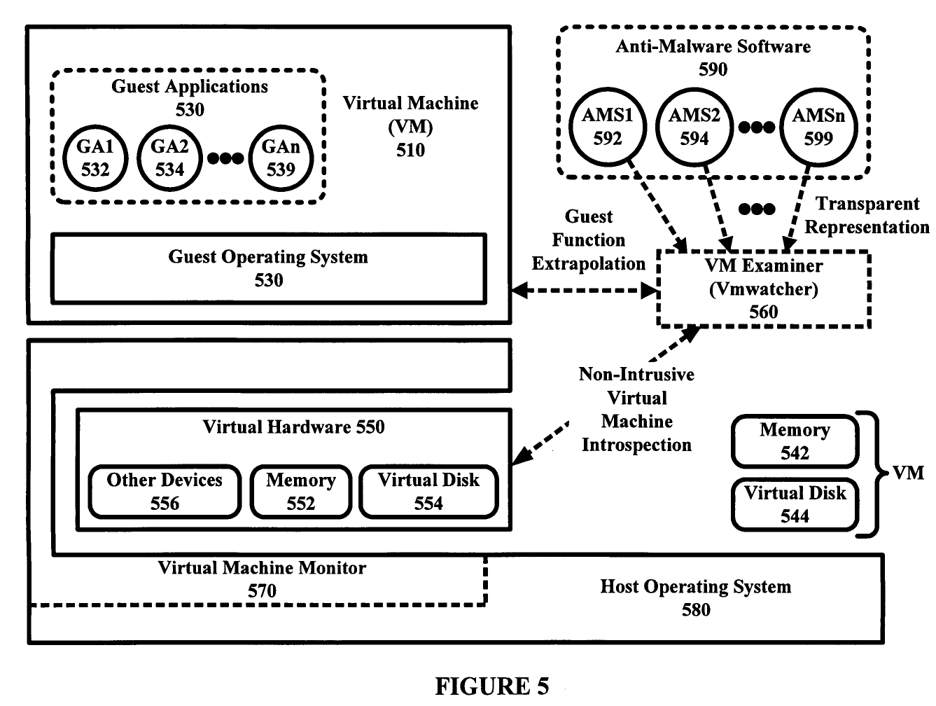

Referring to FIGS. 3 and 5, a malware detection system 305 is shown. The modules comprising this system include at least one guest operating system 320, 530 and at least one virtual machine examiner 360, 560.

The guest operating system 320, 530 may run on at least one virtual machine 310, 312, 319, 510. The guest operating system 320, 520 may run one or more guest applications 332, 334, 339. Each of these guest applications 332, 334, 339 should have one or more guest functions. The virtual machine 310, 312, 319, 510 may reside on a host operating system 380, 580. The virtual machine 310, 312, 319, 510 may have virtual resources 340 that include virtual machine memory 342, 542 and at least one virtual disk 344, 544. Quite possible, virtual resources 340 (such as the virtual machine memory 542 and at least one virtual disk 544) may also be found in one or more virtual hardware 350. In a separate embodiment, the virtual resources 340 may also include at least one virtual network interface 556, which may be found in the virtual hardware 350.

The virtual machine examiner 360, 560 may reside outside the virtual machine 310, 312, 319, 510. Yet, at the same time, the virtual machine examiner 360, 560 is also capable of running on the host operating system 380, 580. Modules that make up the virtual machine examiner may include a virtual machine inspector 362, a guest function extrapolator 364, and a transparent presenter 366.

The virtual machine inspector 362 can be configured to retrieve for inspection virtual machine internal system states from the virtual resources 340. Retrieval may be based on non-intrusive virtual machine introspection without perturbing the execution of the virtual machine internal system states. The virtual machine internal system states may comprise virtual memory states (which may be found in the virtual memory 342, 352, 542, 552) and virtual disk states (which may be found in the virtual disks 344, 354, 544, 554).

Furthermore, the virtual machine inspector 362 can also be configured to retrieve virtual network interface states from the at least one virtual network interface 356, 556. This type of interface may be found as part of the virtual resources and serve as an interconnection point as previously mentioned.

The guest function extrapolator 364 can be configured to interpret the virtual memory states and the virtual disk states.

The transparent presenter 366 can be configured to encapsulate and present the interpreted virtual memory states and the interpreted virtual disk states to anti-malware software 390, 590. One or more anti-malware software 392, 394, 399, 592, 594, 599 may be configured to use the interpreted virtual memory states and the interpreted disk states to detect system compromises.

Not only can the malware detection system 305 retrieve, interpret, and transparently encapsulate and present virtual machine internal system states, but it can also do the same for virtual machine internal system events. Such events can be retrieved from the virtual resources 340 for inspection. Retrieval of these events is also based on non-intrusive virtual machine introspection without perturbing their execution. The virtual machine internal system events may comprise virtual memory events (which may be found in the virtual memory 342, 352, 542, 552) and virtual disk events (which may be found in the virtual disks 344, 354, 544, 554).

The malware detection system 305 may use the virtual machine inspector 362 may be configured to retrieve the virtual memory events from a virtual machine monitor 370, 570. Generally running between the host operating system 380, 580 and the virtual machine 310, 312, 319, 510, the virtual machine monitor 370, 570 may be configured to intercept the virtual memory events. Upon interception, the guest function extrapolator 364 may extract semantic-rich data by interpreting the virtual memory events. Afterwards, the transparent presenter 366 may encapsulate and present the interpreted virtual memory events to the anti-malware software. Like above, the anti-malware software 390, 392, 394, 399, 590, 592, 594, 599 may be configured to use the virtual memory events to detect system compromises.

Similarly, the malware detection system 305 may also use the virtual machine inspector 362 to retrieve the virtual disk events from a virtual machine monitor 370, 570. The virtual machine monitor 370, 570, running between the host operating system 380, 580 and the virtual machine 310, 312, 319, 510, may be configured to intercept the virtual disk events. After interception, the guest function extrapolator 364 may extract semantic-rich data by interpreting the virtual disk events. Then, the transparent presenter 366 may encapsulate and present the interpreted virtual disk events to the anti-malware software 390, 392, 394, 399, 590, 592, 594, 599 for detecting any system comprise.

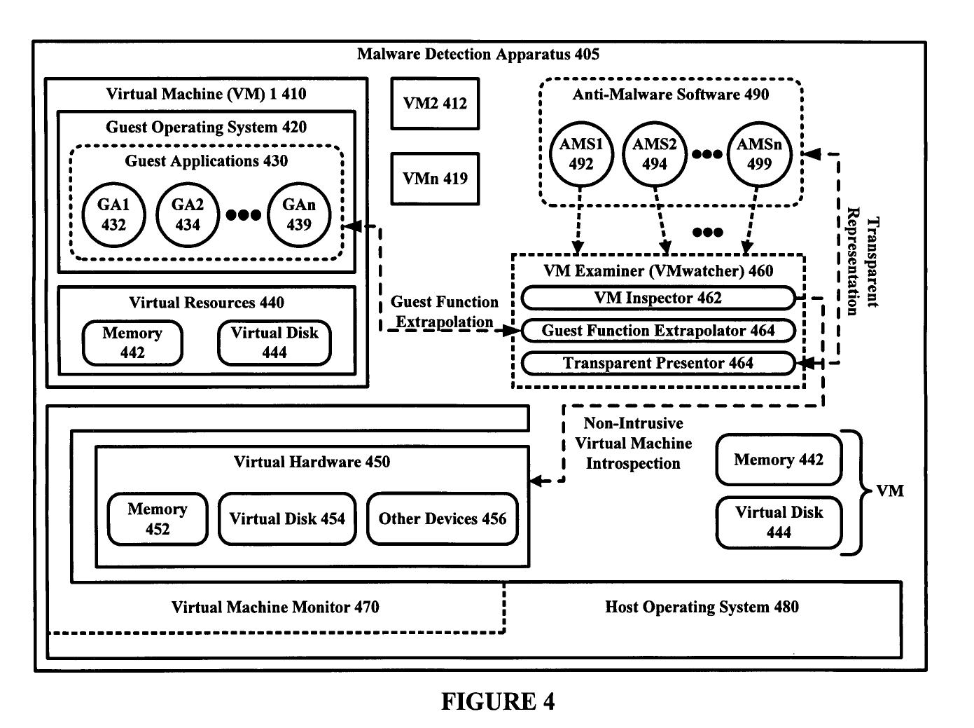

Referring to FIG. 4, a malware detection apparatus 405 is shown. The same modules and components used to create the malware detection system can be used to create a malware detection apparatus (such as a computer or processor) or “other device” that is configured or configurable to execute embedded instructions. Examples of “other device” include, but are not limited to, PDA, cd player/drive, dvd player/drive, cell phone, etc. Hence, the malware detection system may include a guest operating system and a virtual machine examiner. Modules comprising the virtual machine examiner 460 may include a virtual machine inspector 462, a guest function extrapolator 464, and a transparent presenter 466. The features, configurations and capabilities taught herein also apply to the apparatus's modules.

### I. VMWATCHER

### An Overview

Three virtualization-based key techniques that enable the external execution of anti-virus software and realize the “out of the box” vision are presented. After that, interesting opportunities that are enabled by VMwatcher to detect stealth malware are discussed.

A. Key Techniques

FIGS. 3 and 5 show the three key techniques behind VMwatcher: non-intrusive VMI, guest function extrapolation, and transparent representation. Non-intrusive VMI allows an external authorized process to collect and examine states and events related to a VM without perturbing its normal execution. Guest function extrapolation interprets these states and events with high-level semantic information. Transparent representation supporting their normal operations by encapsulating the collected information and making them “native” to legacy anti-virus software.

1. Enabling External Inspection with Non-Intrusive Virtual Machine Introspection

The first challenge is to allow an authorized external process to examine and monitor system state of a VM. As mentioned earlier, VMwatcher uses new non-intrusive improvements on the VMI technique initially proposed by Garfinkel and Rosenblum to externally monitor states (e.g., disk blocks, physical memory pages, registers, etc.) and events (e.g., interrupts, memory, I/O accesses, etc.) related to a VM. As noted before, Garfinkel and Rosenblum's VMI technique can be intrusive in that it disallows or prevents unauthorized modifications (e.g., on the kernel's text segment) initiated by an internal process. The intrusive manner may introduce some undesirable consequences, such as inconsistencies in the system state that essentially perturb the VM execution.

Considering the current focus is geared towards malware detection (not malware removal and recovery), VMwatcher takes a non-intrusive VMI approach. This design decision may disable certain features (e.g., virus quarantine) in commodity anti-virus software. Also, by design, non-intrusive VMI would not likely support anti-virus software if they require the installation of their own hooks to proactively intercept file read and write operations.

Here, a threat model is assumed where an attacker arbitrarily compromises the target system (e.g., a kernel-level rootkit installation), but cannot break out of the target system and corrupt the VMM or the VMI. It may be relatively harder for attackers to compromise them because their code base tends to be smaller and more stable than the code in the legacy operating systems. In addition, the assumed threat model seems to be consistent with other VM-based security research projects [6, 7, 8, 10, 15, 16].

2. Bridging Semantic Gap with Guest Function Extrapolation

The second challenge is how to understand and interpret the states and events that are collected and observed via external inspection. To address this challenge, first observe that the guest OS already contains necessary functionalities that needed to interpret those states and events. As a result, one may externally extrapolate those guest functionalities to bridge the semantic gap. For example, based on the inspection of the physical memory pages that are being allocated (by the VMM) to a VM, one may extrapolate guest memory functionality to extract the list of running processes (including their corresponding attributes, such as process names, user IDs, group IDs, etc.). Additionally, one may also extrapolate the list of kernel-level modules inside the VM, a capability that may be extremely useful when detecting advanced kernel-level rootkits.

Such guest functionalities may be externally extrapolated and do not reside inside the target guest OS. Hence, any software running inside a VM may not be able to tamper with the extrapolated guest functionalities. This property may be directly inherited from the strong isolation provided by current VMMs.

3. Supporting Legacy Anti-Virus Software with Transparent Representation

As mentioned earlier, the proposed “out of the box” malware detection approach essentially breaks the implicit assumptions of deploying and running traditional anti-virus software. This breakage may lead to the possibility that they cannot be directly supported. Though a VMI-aware security software [7, 10] may take advantage of its capabilities and utilize new possibilities, existing legacy anti-virus software will simply operate in their traditional ways. For instance, McAfee VirusScan examines local file directories and attempts to spot existing viruses or worms, if present in the examined directories. Similarly, Tripwire assumes a standard UNIX-like file system layout and calculates the checksums of encountered files and directories to identify possible changes.

A solution to this challenge is to encapsulate the exported semantic-rich information from a VM and seamlessly present them in the same abstraction that is “native” to legacy anti-virus software. For example, semantic-level information/objects (such as files, directories, processes, kernel modules, etc.) can be extracted and presented to anti-virus software. Transparent representation essentially intercepts the read operations of legacy anti-virus software and redirects them to the virtualized resources that are being allocated and used by a VM. In some prototypes, legacy anti-virus software provided as kernel-level services are not supported. However, the new opportunities enabled by VMwatcher provide an interesting alternative, especially when detecting more advanced stealth malware (such as kernel-level rootkits, etc.).

B. New Opportunities

Beyond the support for traditional anti-virus software, the externalization with VMwatcher also provides new opportunities for malware detection. More specifically, VMwatcher enables live cross-view differential analysis on a suspicious system by correlating an internal and external view. Any discrepancy between these two views can indicate the existence of stealth malware on the system. For example, running the “ls” command inside a Linux VM can provide an internal view of those files under current directory. Note that this internal view might be altered or manipulated by stealth malware since there may exist a significant number of malware capable of manipulating the internal view and deliberately hide the existence of certain files or processes. To prevent this kind of alteration, VMwatcher provides an unmasked external view on the states of a VM, which may then be used to corroborate the internal view. Any difference can immediately lead to the detection of hiding malware. The view need not be limited to a VM's persistent states, such as disk files and directories. It can also be related to a VM's volatile states, such as running processes, loaded kernel-level modules, and current statistics about a particular NIC device. A number of real-world examples can be seen below.

The notion of cross-view differential analysis was initially proposed by Wang et al. in their Strider GhostBuster system [25]. The Strider GhostBuster system can perform two scans—an inside-the-box infected scan and an outside-the-box clean scan. The resulting two scans may then compared for malware detection. The outside-the-box clean scan is derived by rebooting the examined machine with a clean OS (i.e., WinPE CD), which unfortunately, destroys current non-persistent states (running processes, kernel-level modules, and others).

In contrast, embodiments of the VMwatcher preserve these non-persistent states by collecting them while the target OS is still running. As a result, VMwatcher is able to perform a “live” cross-view differential analysis on the system without the need to reboot the system. This capability may be important, especially when detecting those advanced kernel-level rootkits that hide running processes or kernel modules. One possible concern is to ensure that the two views for differential analysis are collected at the same time. However, in practice, under a small time skew (e.g., less than 1 second), problems were not encountered that lead to false positives.

### II. DETAILED DESIGN

A. Non-Intrusive Virtual Machine Introspection

Embodiments of VMwatcher run on the host OS domain and externally examine resource states (of a VM) that are being used or modified by a VM. In a current embodiment, disk states and memory states may be of interest. From the disk states, one can extract high-level meaningful persistent state information, such as, but not limited to, files and directories. Memory states can be used to extract non-persistent state information, such as, but not limited to, running processes and loaded kernel modules.

Several challenges exist in achieving efficient external inspection. First, VM states are dynamic. A VM may dynamically launch a new process or delete a local file at its will. When a VMwatcher observes the presence of a local file, it might be removed even before the external scanning is completed. Moreover, a subtle cache inconsistency problem may occur if a file that is being modified by an internal process is not timely reflected in the disk. It should be noted that the modified contents or states can be cached for performance reasons. Second, to ensure state consistency, VMM usually grants an exclusive access (e.g., with a write lock) on the virtualized resource (e.g., a disk file emulating a disk drive or physical memory) to a VM. As a result, it may prevent an external process to even “open” it. Third, different VMM techniques usually impose their own interfaces for the VM state access, thus posing additional complexities for the actual VMI implementation.

To address these challenges, certain VMM features or host OS-level services may be needed. Particularly, VMwatcher may need a common VMM capability to temporarily pause and later resume a VM execution. A paused VM execution should allow VMwatcher to take a consistent view on its dynamic states while avoiding perturbations on the running system. A two-pronged approach may be taken for the cache inconsistency problem. First, VMwatcher may provide unbuffered reading on the examined resources so that every read will actually reflect current state. Second, certain features of VMMs may also be leveraged. For example, VMware contains the “disable write caching” option for a VM, which essentially flushes the “dirty” content directly to the disk at the VMM level. Note that this option may incur non-trivial performance overheads, especially for a VM with I/O intensive operations. Due to the non-intrusive consideration, one should not interfere with the guest kernel. As such, the guest kernel may still buffer the modified file content for performance reasons, which could be potentially exploited by attackers. This attack is discussed below.

Additionally, difficulties may be encountered in Windows regarding the exclusive write lock by a running VM instance. It should be noted that the file lock under UNIX, by default, is advisory [57]. This aspect means that one can ignore the lock and “read” the file even when it is locked. However, the file lock in current versions of Windows imposed by a running VMware-based VM instance is mandatory, which means another host process, such as VMwatcher, may not be able to read the locked file. There are two possible ways to get around this problem. One is to leverage the Windows system service (e.g., the Volume Shadow Copy Service [56]) to create a shadow copy of the locked file. Once created, the shadow copy will be accessed by VMwatcher for inspection. Another way is to write a device driver that essentially subverts the host Windows kernel and allows VMwatcher to read the locked file directly through the device driver while ignoring the write lock. Preferably, a non-intrusive VMI should not modify the locked file.

B. Guest Function Extrapolation and Transparent Representation

Once raw states about a VM can be externally examined, embodiments of VMwatcher may extrapolate guest functionalities to extract high-level semantic-rich information (e.g., files and processes) and then represent them to anti-virus software. Extrapolations and representations may be differentiated on two main resources: disk and memory.

1. Disk States

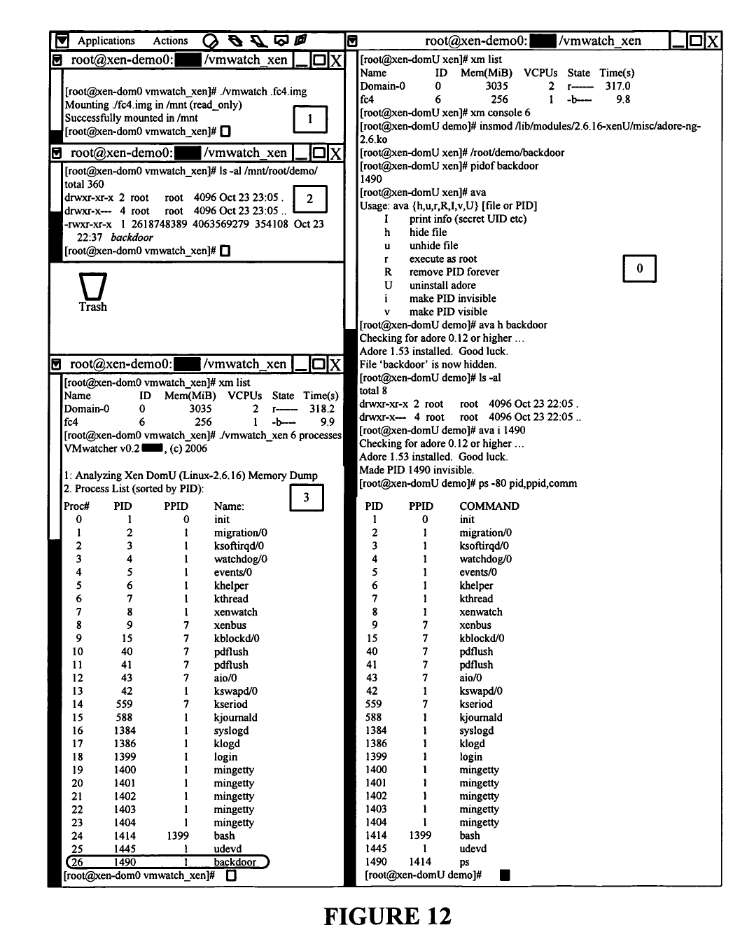

It is surprisingly straightforward to interpret and represent disk states. The only extrapolation one may need is to infer the disk format and its file system. Note that Xen and UML do not introduce new virtual disk formats as they can be regular partitions or files with supported file systems (e.g., ext2/ext3). VMware introduces its own virtual disk format, whose specification is now open to public. As such, once one is aware of the disk format and the file system, the disk states of a VM can just be lively interpreted and “mounted” onto a local directory, which may be considered as a form of transparent representation and be readily subject to external scanning. This process is relatively straightforward in Linux environments. However, it may not be as easy in Windows platforms. The reason is that the Windows kernel does not have the corresponding drivers for the Linux root file systems, including ext2/ext3. To resolve such problem with Windows platforms, the present invention provides for a new Windows device driver that supports the ext2 file system for the experiment. This solution is shown in FIG. 12.

2. Memory States

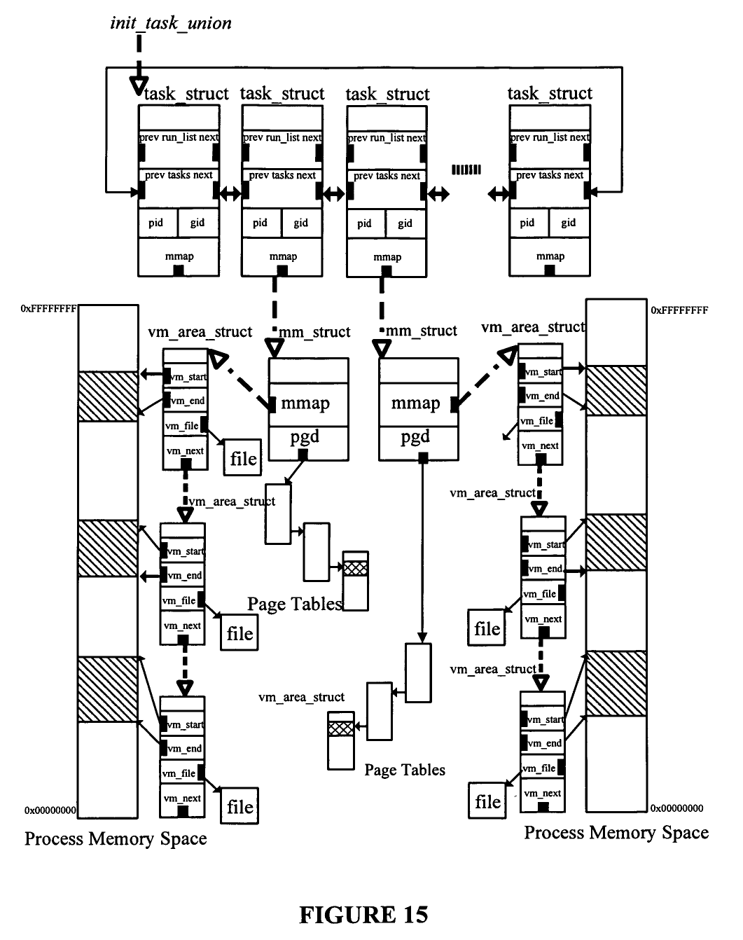

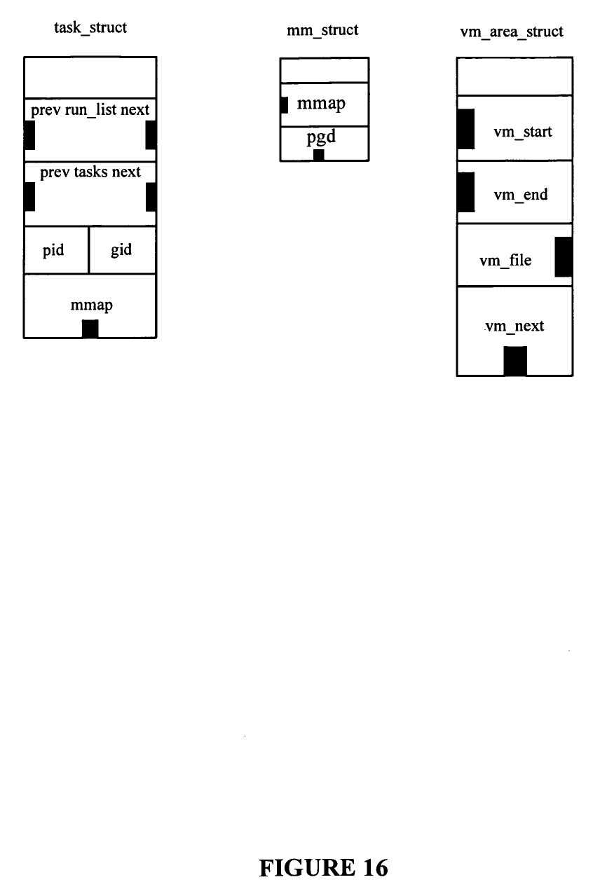

External interpretation and representation on raw memory pose a significant challenging task. For the sake of simplicity, the following discussion focuses only on current popular 32-bit architecture (that implies the addressable memory range is [0, 4G−1]). There exists a Physical Address Extension (PAE) feature in modern OS implementations that allows support for physical memory with a size of more than 4 G in current 32-bit architectures. Using Linux as an example, the total 4 G memory space is split between user space (the bottom 3 G memory) and kernel space (the top 1 G memory). The Linux kernel is mapped into every user-level process, starting at virtual address 0xC0000000. Due to the way the physical memory is managed, the first Linux kernel page (with virtual address 0xC0000000) is located in the first physical memory page. In other words, if there is a file containing the raw memory of a running VM, the offset 0 in the memory file corresponds to the current memory address 0xC0000000 inside the VM. Based on this understanding, one can further identify those important kernel-level data structures. For instance, in Linux, processes are represented by a process control block (defined as task_struct); running processes (in a normal system) are linked by a doubly linked list. The head of this list is kept in a structure called the init_task_union, which can be exported by the kernel and be found in the System.map file. With this value, one can further parse the raw memory image and traverse the doubly linked list to retrieve all of related information (e.g., page tables and memory layout in the, for example, mm_struct, data structure) about running processes. FIG. 15 shows an incomplete graph linking together a number of important kernel-level data structures (in Linux) that is helpful for memory extrapolation purposes. To illustrate a closer look at several of these structures, FIG. 16 shows a separate and individual task_struct data structure, a separate and individual mm_struct data structure, and a separate and individual vm_area_struct data structure.

From the same memory image, the present invention also allows for the casting and reconstruction of a number of other important kernel data structures (e.g., the system call table, the interrupt descriptor table, and the kernel module list). It may also allow for the identification of areas containing core kernel instructions or instructions in the loadable kernel modules. It is should be noted that when accessing a user-level memory address (<3 G), it is usually referring to a virtual memory address specific to a particular process running inside the VM. Since VMwatcher is running outside of the VM, it may need to translate the virtual memory address into the corresponding physical memory address, which can then be accessed through the low-level VMM observations.

Essentially, the memory extrapolation technique is to obtain these kernel-level data structures and extrapolate guest memory functions by walking through these data structures. In Linux platforms, the final result is an external transparent representation of the internal /proc file system. For performance reasons, the final representation may be dynamically generated only when it is being accessed. In Windows platforms, though this memory extrapolation technique is able to successfully retrieve and dump every memory page associated with each internal process, the memory scanning behaviors from commodity anti-virus software are not yet supported. One possible alternative is to dump the process images as individual files that can be subject to scanning by anti-virus software.

A number of challenges may be encountered in the implementation of some embodiments. First, in some commodity OSes such as Windows, the symbols like init_task_union may not be available. Under such circumstance, memory extrapolation essentially resorts to a full scan on the raw memory by looking for some certain “signature” that is unique to a particular kernel-level data structure. For example, we have used so far 0x03001b0000000000 to identify potential process instances in the Windows XP raw memory file. The full scan may inevitably incur scanning delay. Second, when there is memory contention on a high-workload system, some memory pages initially allocated to a process may be temporarily swapped out. If a memory page is swapped out, the bits 0 (PRESENT bit) and 7 (PROTNONE bit) in the corresponding page table entry may be cleared and additional information written to provide “leads” on how to find out the swapped-out page in the backing storage, which may be used later to swap the page back. Memory extrapolation utilizes this information to find out the swapped page in the backing storage. Third, different versions of the same OS may have variations even for the same kernel-level data structure. For example, the offsets to the PID within the EPROCESS block (the Windows counterpart of process control block) in Windows NT, 2000, XP, XP SP2, and 2003 are respectively 0x94, 0x9C, 0x84, 0x84, and 0x84. In some embodiments, one may assume such knowledge is already known and can be utilized for memory extrapolation purposes. Based on current implementation, the VMwatcher prototype is able to successfully scan Windows XP/2000 raw memory images, as well as all experimented Linux raw memory images.

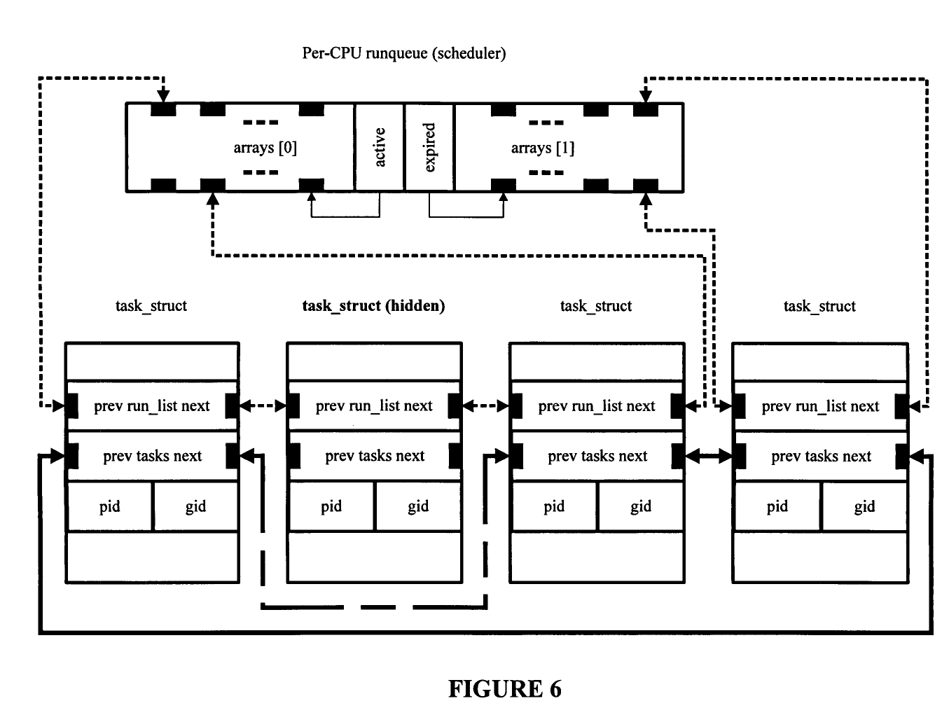

Another challenge comes from possible advanced kernel-level attacks. Petroni et al. [20] has described a data-only technique to hide running processes in Linux without modifying any kernel code. This date-only attack is the same in nature as the Direct Kernel Object Manipulation technique implemented by the FU rootkit [33] in the Windows platform. To illustrate this attack, FIG. 6 shows how normal running processes in Linux are linked with a doubly linked list, called the “all-tasks list,” while an attack process is successfully hidden.

The all-tasks list may be maintained in the Linux kernel for accounting purposes. It can even be accessible through the /proc file system (e.g., with the readdir( ) system call) that is being used by user-level programs, such as “ps.” However, it should be noted that this all-tasks list is not the list that is actually used in the CPU process scheduling. As a result, if an advanced attacker simply removes an attack process from the all-tasks list (as shown by the solid lines in FIG. 6), while still leaving it in the scheduling list (as shown by the dotted lines in FIG. 6), it can successfully hide the process while still allowing the process to be executed. Such attack can be defeated by parsing the memory through the CPU scheduler list (as defined in the runqueue data structure). The parsing result with the CPU scheduler can be compared with the original all-tasks list and any discrepancy should reveal the hidden process. Similarly, in the Windows platform, there are three scheduling-related lists. These include KiDispatcherReadyListHead, KiWaitInListHead, and KiWaitOutList. They may be parsed to detect similar DKOM-based attacks in Windows platforms.

It is noted that existing hardware has the capability of automating the process of traversing the page table for the address translation. However, it has the implicit assumption that the running process has the same page table base (CR3) as the memory address to be accessed. As a result, an embodiment of the present invention allows for externally identifying and walking through the page table of an internal process to obtain the corresponding physical memory address and read its content for inspection. The corresponding code is illustrated below in function vmwatcher_vir_mem_read32, where addr is the virtual memory address to be queried. The task points to the process control block (assuming the task_struct data structure in FIGS. 15 and 16) of an internal process of interest. The pde and pte respectfully refer to a page directory entry and a page table entry associated with the internal process. The vmwatcher_phy_mem_read32 reads the actual physical memory content with the given physical memory address from VMM-based observations.

unsigned int vmwatcher_vir_mem_read32(task, addr) {

| /* Step 1: | | obtain the page directory entry */ |
|---|---|---|
| pde_addr | = | task->mm->pgd + (addr >> 20) &~3; |
| pde | = | vmwatcher_phy_mem_read32(pde_addr); |
| /* Step 2: | | obtain the page table entry */ |
| if ( !(pde & PG_PRESENT) ) return −1; | | |
| pte_addr | = | pde&~0xfff + (addr >> 10) & 0xffc; |
| pte = vmwatcher _phy_mem_read32(pte_addr); | | |
| /* Step 3: | | obtain the physical address */ |
| if ( !(pte & PG_PRESENT) ) return −1; | | |
| phy_addr | = | pte&~0xfff + addr&0xfff; |

return vmwatcher_phy_mem_read32(phy_addr);

}

Although the above description is in the context of Linux, the guest view casting-based semantic view reconstruction (also guest function extrapolation-based semantic view reconstruction) provides a generic, systematic methodology that can be applied to various VMM platforms (e.g., full and para-virtualization approaches) and operating systems. While different operating systems, service patches, and system configurations may impact the casting of VM states and events, embodiments of the present invention (e.g., guest feature extrapolation (also guest view casting)) methodology remain effective.

### III. EVALUATION

Embodiments of the system were evaluated by deploying a number of real-world anti-virus software and managing them to scan possible malware instances that are running inside virtual machines. In particular, two different sets of experiments were conducted to show: (1) How traditional anti-virus software can be supported by VMwatcher; and (2) How VMwatcher enables a new opportunity to detect the most stealthy and significant threats—kernel-level rootkits. The first set of experiments mainly shows how persistent disk states can be externally extrapolated and transparently represented. The second set of experiments demonstrates how non-persistent memory states can be extrapolated and represented. Finally, some performance measurement results are presented.

A. Supporting Real-World Anti-Virus Software

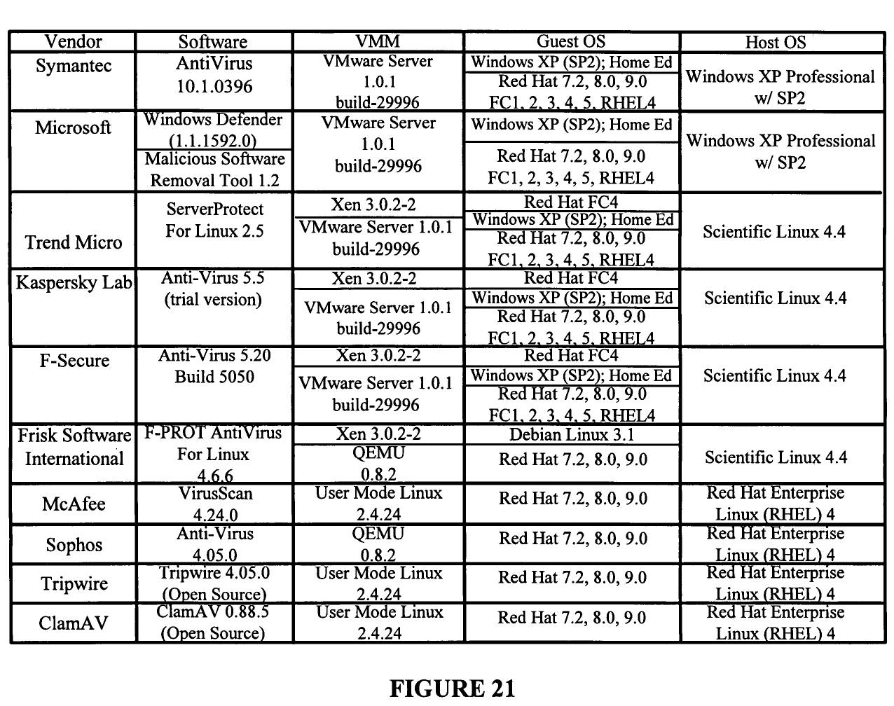

FIG. 21 shows a list of real-world anti-virus software that have been tested with VMwatcher. As VMwatcher essentially makes the whole internal file system accessible to outside, most, if not all, file scanning-based anti-virus software can be readily supported.

The VMwatcher can support at least three different types of VMMs. Nonlimiting examples include VMware, Xen, and User Mode Linux (UML). While Xen and UML support Linux as their guest OSes, as well as their host OSes, the VMware VMM operates differently in that it supports a variety of guest OSes that do not need to be the same as the host OS. This distinction opens up an interesting possibility for cross-platform malware detection. In particular, a malicious software detection tool that is developed for one platform can be readily used for other platforms. For example, Microsoft Windows Defender that is developed for Windows operating systems can be deployed to detect viruses or worms in Linux platforms. Similarly, McAfee VirusScan for Linux, originally only supporting Linux platforms, can be used to scan for viruses in Windows platforms. In the following, an experiment that uses the Symantec AntiVirus software (the Windows version) to detect possible malware instances inside a compromised (VM-based) Linux honeypot is described.

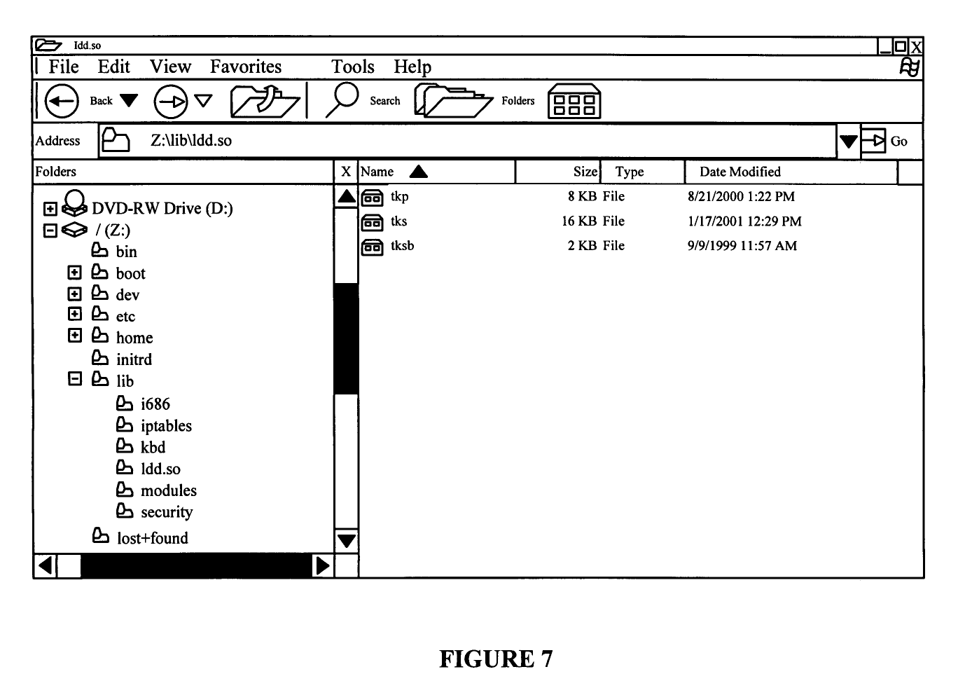

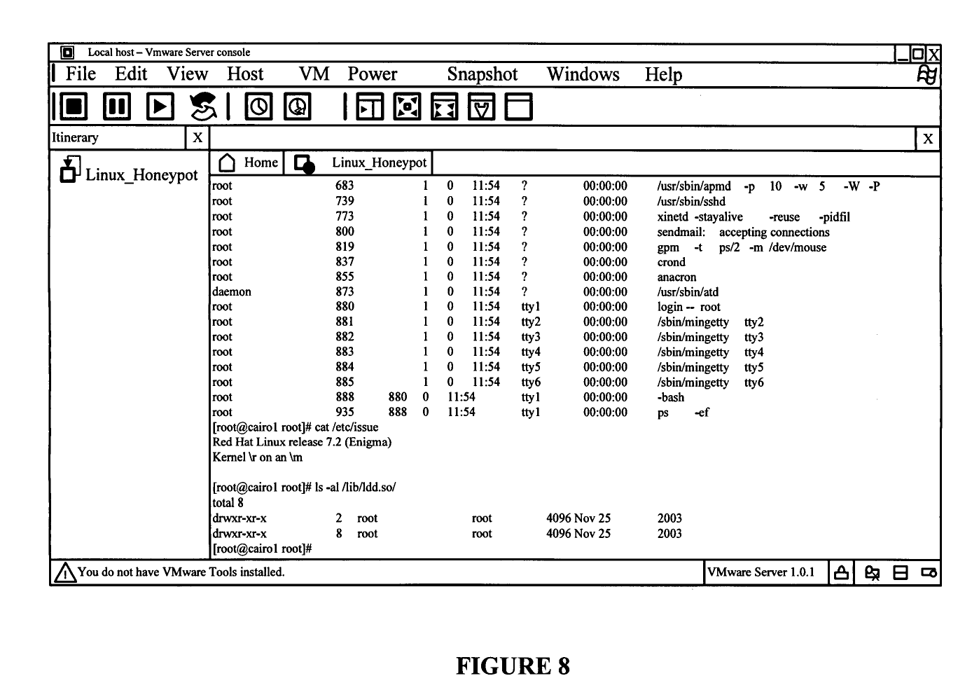

Referring to FIGS. 7 and 8, a compromised virtual machine honeypot (RedHat 7.2) that is externally examined with Windows File Manager is shown. This Linux honeypot was a VMware-based Red Hat 7.2 system that contains a number of remotely exploitable vulnerabilities. In this experiment, an attacker first exploited the Apache web server vulnerability [58] and gained system access. Later on, the ptrace local vulnerability [59] in the unpatched Linux 2.4.x kernel was taken advantage of to escalate the attacker's privilege to system root. Afterwards, a rootkit named SHv4 [18] was installed to hide attack processes and local malicious files. Specifically, the SHv4 rootkit replaced a number of system-wide commands/tools (e.g., ps, is, ifconfig, netstat, syslogd, etc.) with their own tools and made a number of attack files “invisible” (such as those files under the directory /lib/ldd.so). These figures show a screenshot of two different views on the same Linux honeypot. The internal view of the system about the directory /lib/ldd.so is located on the right while the external view with the same directory by the Windows File Manager is shown on the left. The virtual disk allocated for the VM is already externally interpreted and transparently represented as a local “Z:” drive. The inconsistency between the internal view and the external view shown here is most likely an anomaly. Symantec AntiVirus and Microsoft Windows Defender were ran to detect possible malware installations in this compromised system. Symantec AntiVirus reported 21 infected files by this attack, whereas Microsoft Windows Defender reported no single infection. Thus, it seems that the current Microsoft Windows Defender version only detects malware in the Windows platform, while the Symantec AntiVirus software is capable of detecting malware in multiple platforms.

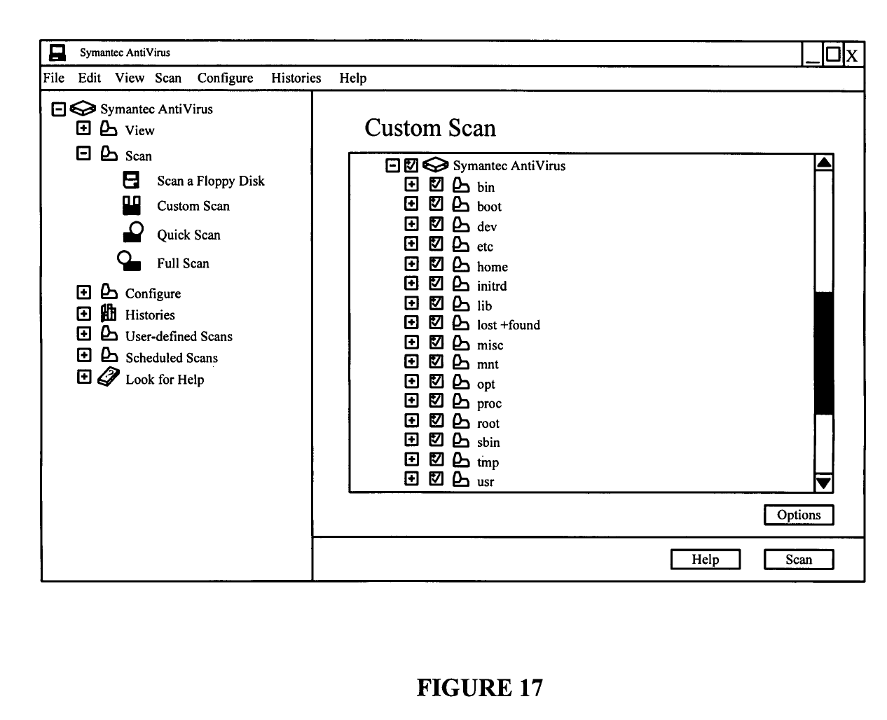

Referring FIGS. 17-20, a further analysis of the experiment is illustrated. These figures contain the following screenshots: one showing the malware scanning results from the Symantec AntiVirus software, and one showing the scanning results from Microsoft Windows Defender. These two scans are performed on the same Linux honeypot image.

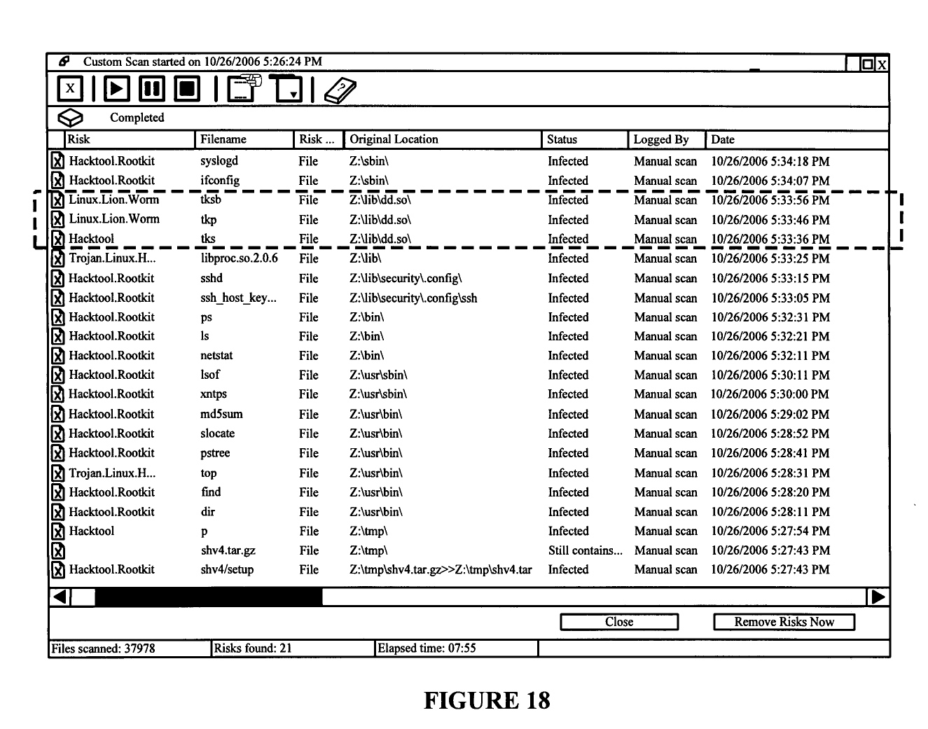

FIGS. 17 and 18 show external inspection of the honeypot with the Symantec AntiVirus software. Specifically, FIG. 17 shows a screenshot of the Symantec AntiVirus software before launching its scanning. FIG. 18 shows a screenshot of the Symantec AntiVirus software after completing its scanning.

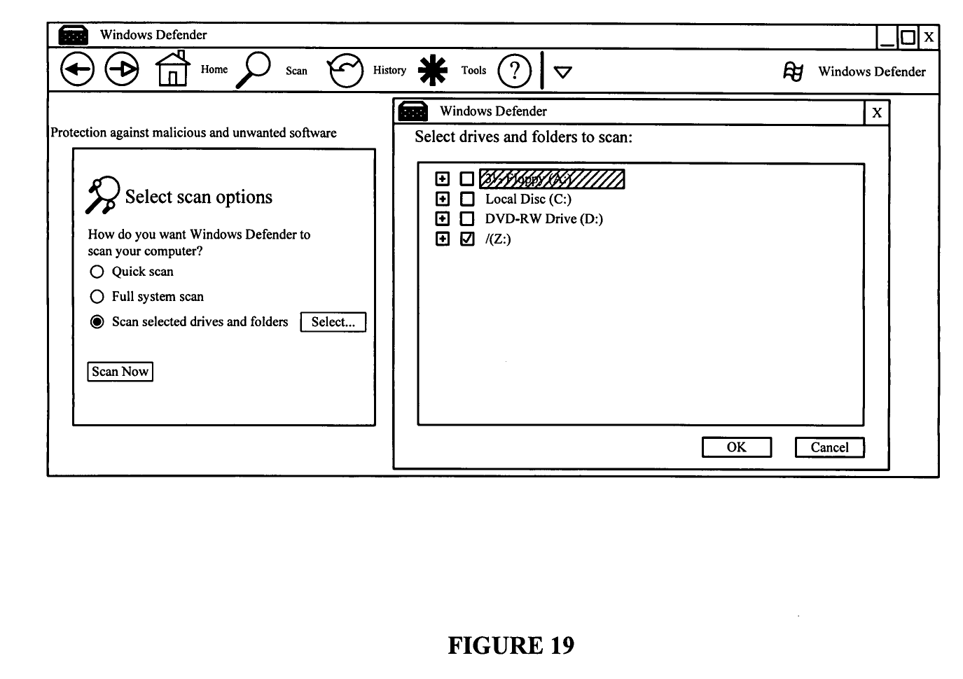

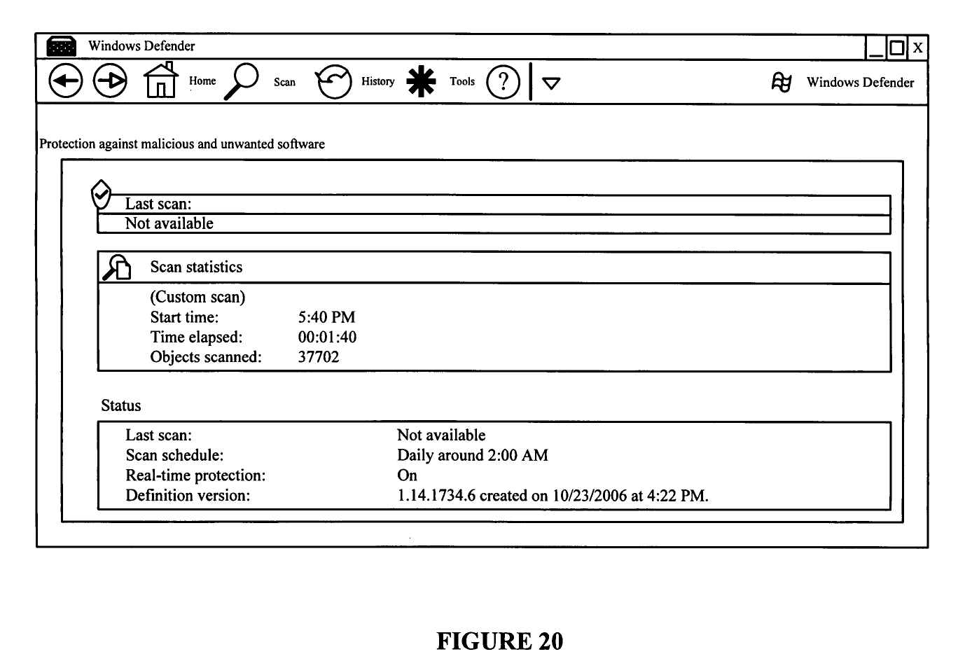

FIGS. 19 and 20 show an external inspection of the honeypot with Microsoft Windows Defender. Specifically, FIG. 19 shows a screenshot of Windows Defender before launching its scanning. FIG. 20 shows a screenshot of Windows Defender after completing its scanning.

It is believed that detection results by the Symantec AntiVirus software misclassified the three files under the directory /lib/ldd.so (as shown in the dashed box of FIG. 18). They are not related to the Linux Lion Worm. Manual analysis reveals that (1) tksb is a shell script that functions as a log cleaner; (2) tks is as a network sniffer; and (3) tkp is a Perl script that essentially looks for user names and passwords in collected network traffic.

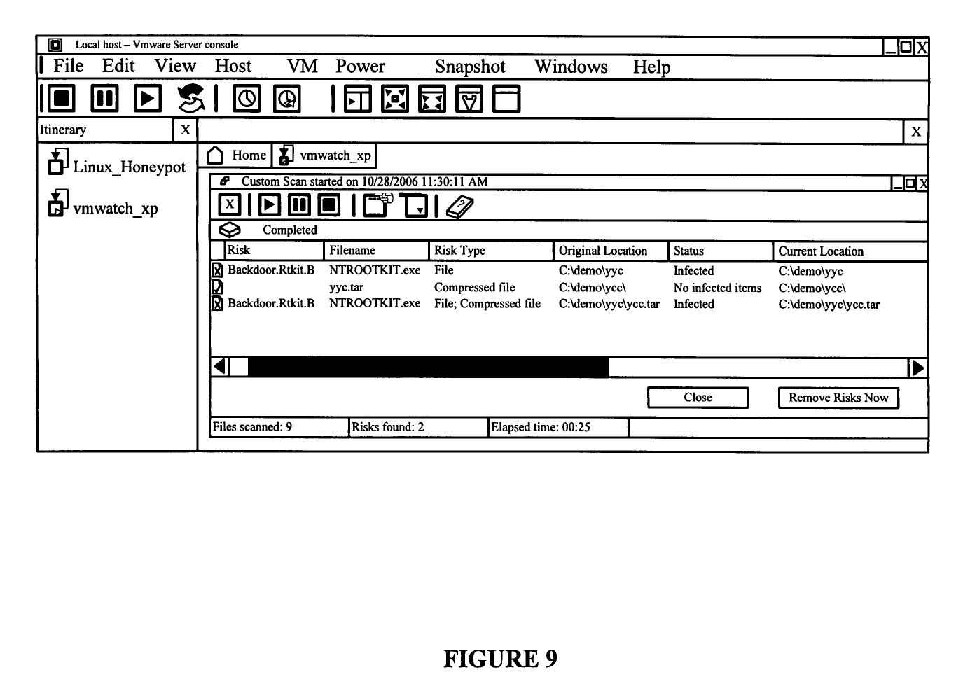

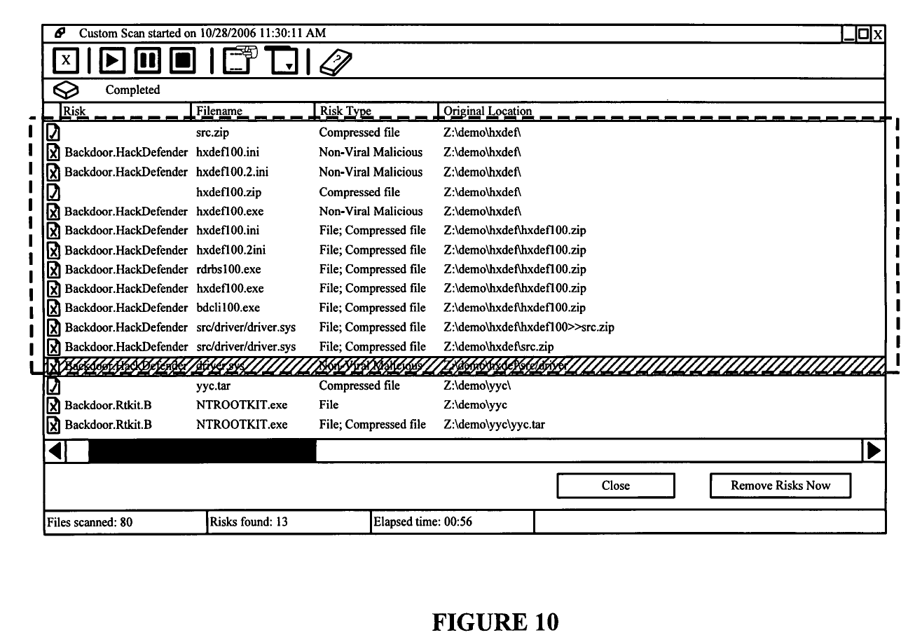

In another experiment, a Windows XP system that is infected by an infamous rootkit (i.e., Hacker Defender or hxdef [36]) was run. This system ran on top of VMware as a VM. Both host OS and guest OS are installed with the same version of Symantec AntiVirus software. With the same software, an internal scan and external scan are conducted. Their results are shown in FIG. 9 and FIG. 10, respectively. FIG. 9 shows the internal scan performed by an internally-running Symantec AntiVirus Software, whereas FIG. 10 shows the external scan performed by an externally-running Symantec AntiVirus Software. The dashed box in FIG. 10 highlights those files that are hidden from the internal scan, but identified by the external scan.

It is interesting to point out that hxdef is able to hide processes and/or files based on a configuration file. In this experiment, the default configuration was used. Particularly, in the default [H<<<iddenT>>a/”ble] option, it contains >h” xdef”*. These configuration entries are obfuscated by hxdef, which essentially ignores special characters such as |, <, >, :, \, / and “. As a result, it may attempt to hide any files, directories, or processes if their names start with the “hxdef” string.

In the internal scan (as illustrated in FIG. 9), the Symantec AntiVirus software was instructed to scan the directory c:\demo, where two rootkits files (hxdef [36] and NTRootkit [41]) are located. Here, the hxdef rootkit was installed before the scan; the NTRootkit was not installed. As the figure shows, the NTRootkit is accurately identified, but other hxdef-related files are not detected. However, another run of the Symantec AntiVirus software with memory scanning enhancement was able to successfully identify the hxdef process.

In the external scan (as illustrated in FIG. 10), the same directory is configured for the scanning. In addition to the NTRootkit files, the Symantec AntiVirus software also detected hxdef-related files, including the configuration file hxdef100.ini. The dashed box in the figure highlights those hxdef-related files that are successfully identified by the external scan but not by the internal scan. Such malicious files may be surreptitiously hidden by rootkits or other advanced forms of malware. They can still be externally identified since the external scanning behavior and results are not manipulated and/or controlled by internal malware.

Altogether, these experiments show VMwatcher's effectiveness in externalizing anti-virus software to detect viruses and worms that are stored in persistent disk states. In the next section, another application of VMwatcher in detecting advanced malware is demonstrated. This application is a part of non-persistent memory states.

B. Dealing with Stealth Malware

Stealth malware may deeply plant themselves in compromised machines and cause significant challenges for internal malware detectors. Among others, rootkits are considered as one of the most stealthy and significant threats. In this section, the unique capability offered by embodiments of VMwatcher in detecting these advanced stealth malware is demonstrated. The detection from VMwatcher is based on the exact nature and purpose of rootkits, especially in hiding attack processes and preventing certain files from being “visible.” The experiments described here deal with Windows-based rootkits and Linux-based rootkits.

1. Windows Rootkits

Experiments with more than 10 Windows rootkits were conducted. Some of the rootkits (including, but not limited to, AFX [29], hxdef [36], Vanquish [53], and NTIllusion [11]) are considered as user-level rootkits as they mainly infect user-level library API functions. These user-level rootkits are relatively easy to detect as the underlying OS kernel can still be trusted. However, some more advanced rootkits (such as FU [33]/FUTo [34], HE4Hook [35], and NTRootkit [41]) are kernel-level rootkits that can substantially subvert the kernel and make them extremely hard to detect. It is encouraging to point out that embodiments of VMwatcher are surprisingly able to defeat all of these experimented rootkits and accurately identify running processes and disk files even though they may be deliberately hidden by rootkits. As previously shown, a one user-level rootkit example (namely hxdef) is able to successfully hide the presence of malicious processes and related files from user-level programs (e.g., Windows File Manager and Windows Task Manager). The following shows experiments with a Windows kernel-level rootkit (i.e., the FU rootkit).

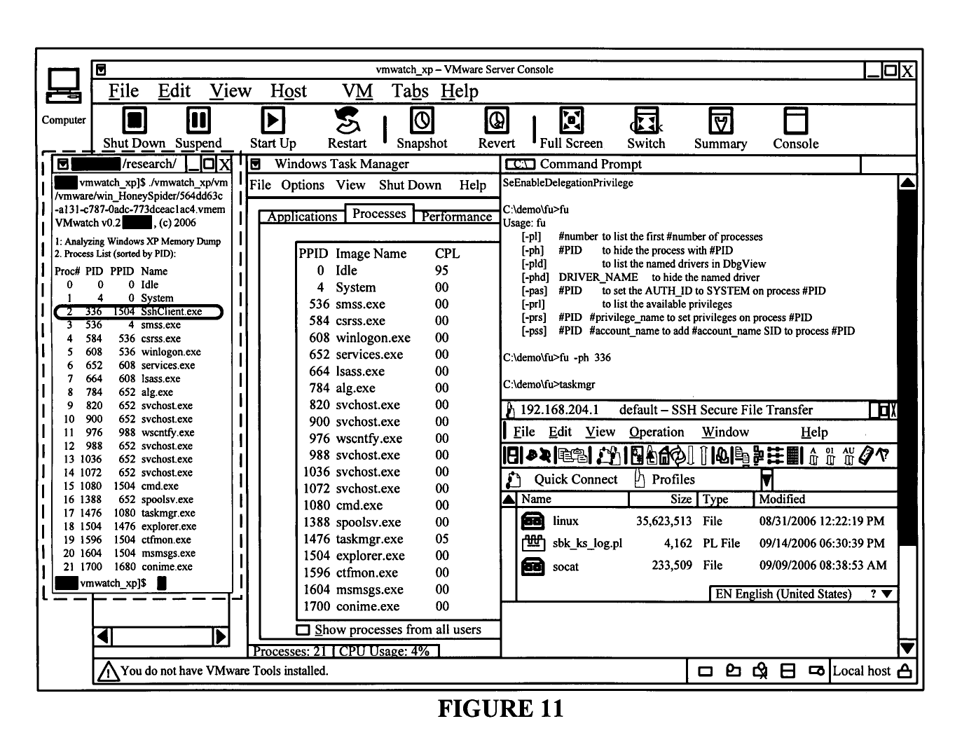

One main design goal of the FU rootkit is to hide running processes in a compromised machine. It achieves its goal through a technique called Direct Kernel Object Manipulation without relying on any existing common hooking techniques. FIG. 11 shows a VMware-based Windows XP VM infected by the FU rootkit. More specifically, FIG. 11 shows a screenshot when the FU rootkit is used to hide a process with its PID 336. This figure shows a Windows XP system that is instantiated as a VMware-based VM while the host OS is running Linux (more accurately, Scientific Linux 4.4). However, it should be noted that this screenshot does not result from a real-world attack. Within the Windows XP, a command shell (PID: 1080) may be created and used to invoke the FU rootkit to hide a process whose PID equals 336. This hidden process corresponds to a running SSH client program (e.g., SSH Secure File Transfer (version 3.2.9)). This screenshot also shows help information on how to invoke the FU rootkit and current Windows Task Manager output. Essentially, the Windows Task Manager output reveals current interaction with the SSH client process while being successfully hidden.

On the left of FIG. 11, the VMwatcher output (encapsulated with a dashed box) that is generated by an external full scan on current memory states of the running Windows XP system is shown. In particular, it contains a list of internal running processes. The small box with solid lines further highlights a process named SshClient.exe that is being hidden by the FU rootkit. Although this rootkit attack is manually conducted, embodiments of the VMwatcher system can be used in real-world honeypots to actually detect in-the-wild attacks. For instance, recent incidents show that the same FU rootkit has already been used to hide the presences of certain sophisticated botnets, including Rbot [42].

2. Linux Rootkits

In addition to the rootkits on the Windows platform, experiments with more than a dozen rootkits on the Linux platform have been conducted. Similarly, Linux-based rootkits can be classified into two main categories: (1) user-level rootkits (e.g., LRK, torn, R3dstorm, etc.) and (2) kernel-level rootkits (e.g., adore/adore-ng, suckit, superkit, etc.). A one user-level rootkit example (such as SHv4 [18]) that was collected in-the-wild from a compromised honeypot has been shown. These rootkits are able to hide a number of malicious files and attack processes. In the following, experiments with an advanced Linux rootkit (such as adore-ng) are shown. Others similar to this adore-ng experiment are not described here.

Unlike its predecessor (namely adore [48]), which hijacks a number of syscall table entries, adore-ng [47] subverts the kernel by directly replacing the kernel-level directory handler routines with its own ones. Hence, it provides the capability of manipulating information about the root file system (“/”) and the “/proc” pseudo-filesystem. The “/proc” pseudo-file system tends to be frequently used by user-level programs (such as “ps”) to enumerate running processes.

FIG. 12 shows an adore-ng infection against a Xen-based Fedora Core VM. On the right (the xterm window with number 0), the adore-ng kernel-level module (LKM) is first loaded (insmod/lib/modules/2.6.16-xenU/misc/adore-ng-2.6.ko). It is pointed out that there exists a user-level program called ava that can be used to control its functionality. Then, a backdoor daemon is executed (/root/demo/backdoor). After this execution, adore-ng can be instructed to conceal existences of any local file named “backdoor” (ava h backdoor), as well as the backdoor daemon (ava i 1490). As indicated by the pidof backdoor command, the PID of the “backdoor” daemon is 1490. Outputs from the commands “ls” and “ps” are already manipulated to conceal the existences of any file with the “backdoor” name and any process with the PID 1490.

Still referring to FIG. 12, the external examination on the same system is displayed on the left. In particular, the first xterm window with number 1 mounts the Linux VM's virtual disk locally under the /mnt directory. The second xterm window with number 2 lists the file under the directory /root/demo/ within the VM. The third xterm window with number 3 further enumerates current running processes inside the Fedora Core 4 VM. As shown in the xterm window with number 2, the internally-concealed backdoor file is “visible” with VMwatcher. Similarly, the xterm window with number 3 highlights the internally-hidden “backdoor” process with PID 1490. The main reason is that the external view from VMwatcher is not manipulated by the internal adore-ng. The cross-view comparisons effectively expose this stealth rootkit.

C. Performance

This section describes the measured performance of VMwatcher. Here, VMwatcher is operated externally from a VM. As a result, it will not affect the normal run of a VM even when it is being examined. Below are two sets of measurement results.

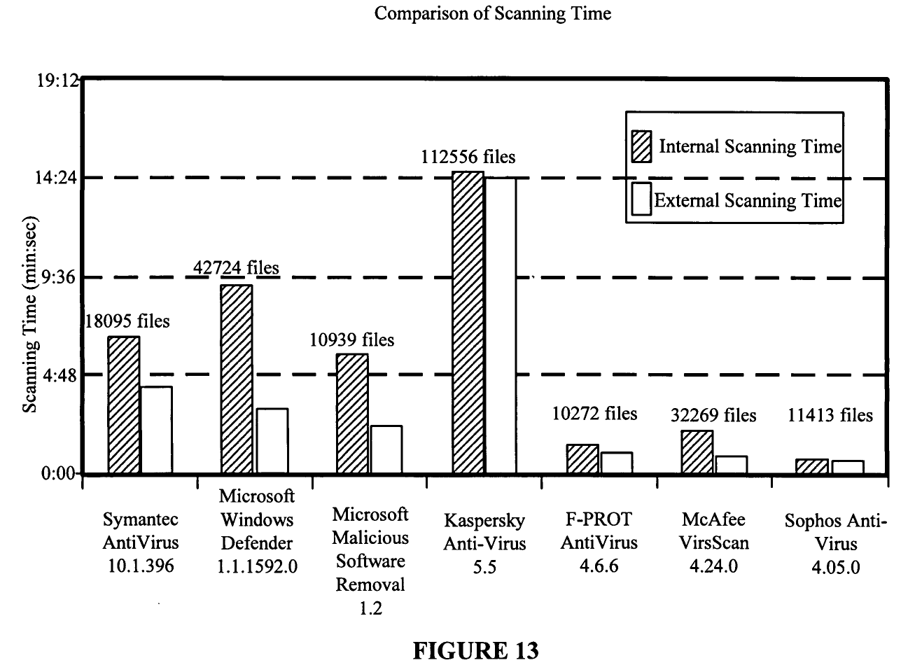

The first set of experiments compare the internal scanning time with the external scanning time on a set of VM systems. Specifically, 7 different anti-virus software programs were chosen to perform an external scan and an internal scan on a particular VM system. Symantec AntiVirus, Microsoft Windows Defender, and Malicious Software Removal Tool may be used to scan a Windows XP VM (2560M memory and 6 G disk) with the host OS running the Windows XP Professional (2 G memory and 120 G disk). The Kaspersky Anti-Virus may be used to inspect a Red Hat 8.0 VM (1 G memory and 4 G disk) with the Scientific Linux 4.4 as the host OS (2 G memory and 180 G disk). F-PROT AntiVirus may be used to examine a Debian 3.1 Linux VM that is based on the Xen VMM while the domain 0 is running Scientific Linux 4.4 (4 G memory and 330 G disk). McAfee VirusScan and Sophos Anti-Virus may be assigned to look into a Red Hat 7.0 VM (128 M memory and 512 M disk) that is running inside a UML VMM. The host OS can be Red Hat Enterprise Linux 4 with 2 G memory and 135 G disk. FIG. 13 shows the results, as well as total scanned files, as a comparison between the internal scanning time and the external scanning time.

It is interesting to point out that an internal examination tends to result in a longer scanning time than its external counterpart. Although such result may sound counter-intuitive, the reduction in external scanning time may actually be reasonable, considering potential disk I/O slowdown introduced by the virtualization and availability of larger memory space in the host domain.

The second set of experiments calculates the time needed to analyze a live raw VM memory. The current prototype assumes that the Windows kernel-level symbols are not available due to its close-source nature. It further assumes that the Linux symbols are available and can be used to speed up memory extrapolation.

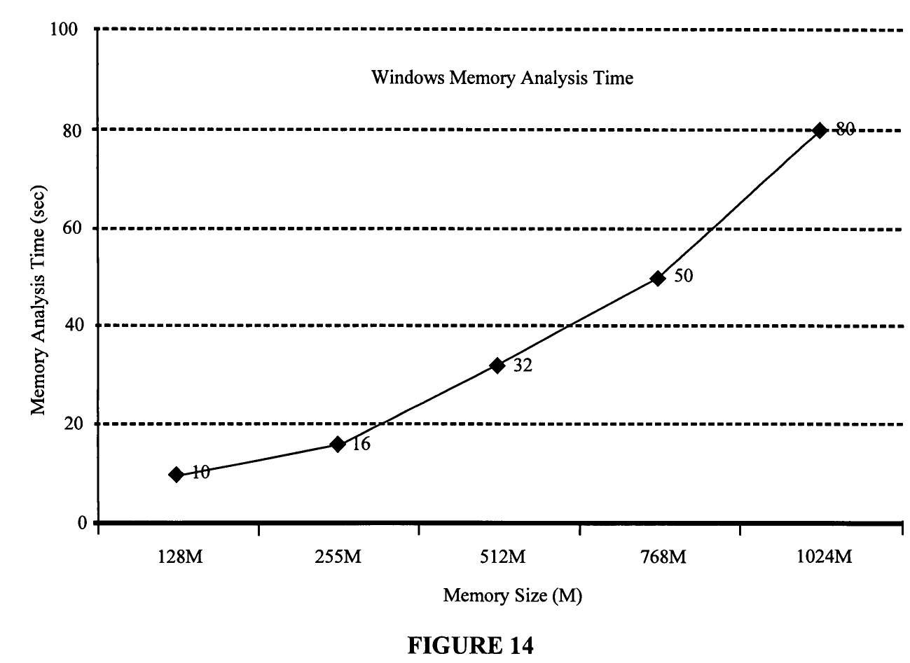

FIG. 14 shows Memory Analysis Latency. More specifically, FIG. 14 shows the analysis time needed to examine a raw Windows memory when the memory size varies from 128 M to 1 G. As expected, analysis time grows linearly with the size of available memory allocated to a VM. Results show that with the availability of Linux symbols, the overall raw memory analysis can be finished just within about 1 second, regardless of the allocated memory size for the VM.

### IV. ATTACKS AND IMPROVEMENTS

One aspect of VMwatcher is that it can externalize the execution of commodity anti-virus software while still allowing them to detect internal malware infections. Three specific attacks against VMwatcher and possible improvements will now be examined.

A. Cache Inconsistency Attacks/Guest Caching Exploitation

This type of attack may occur if a modified file is not timely reflected in the disk that is being examined by VMwatcher. One potential result from this attack is that malware may avoid any file scanning-based detection as it can deliberately hide itself inside the cache without actually committing to the disk. There are two possible counter-measures. The first counter-measure is to make sure that those related guest kernel threads (such as “bdflush” and “kupdate”) in Linux will dutifully look for dirty pages and flush them to the disk. The second counter-measure is to directly examine the cached contents through memory extrapolation. It should be noted that the cached contents may still be contained in the volatile memory and allowing embodiments of VMwatcher to examine their volatile states. However, one challenge here is to seamlessly integrate the memory contents with disk files and natively present them to the external anti-virus processes.

B. Guest Function Subversion Attacks

This attack is based on the observation that VMwatcher may need to correctly extrapolate guest functions for the interpretation and understanding of guest VM states. As such, an attacker can intentionally subvert certain guest functions to mislead the VMwatcher extrapolation. For example, in addition to the original “runqueue” process list (the default process list used by the Linux kernel scheduler as shown, a subverted scheduler can maintain an additional shadow list with hidden processes. Without the knowledge of these subverted guest functions, VMwatcher may not be able to detect them. It should be noted that though it is challenging to understand the details of subverted guest functions, the subversion behavior itself can be externally detected. Considering the same example, the subversion on the original scheduler code will essentially modify the text segment of the original Linux kernel. A simple hash calculation (e.g, MD5) can directly lead to its detection. To counter this type of attack, VMwatcher can further measure the integrity of certain memory ranges (e.g., sys_call_table and kernel text segment). It can also register (which, if modified, could allow critical kernel structures to be relocated) and detect any violations. Note that recent research efforts (such as Copilot [21] and Semantic Integrity [20]) have been proposed to detect these subversion attacks. However, it still remains an important area for further study to accurately identify and efficiently measure the integrity of dynamic kernel data structures.

C. VMM Subversion Attacks

Along with prior research projects on virtual machine-based security [6, 7, 8, 10, 15, 16], VMwatcher assumes a similar threat model where the underlying VMM can be trusted to provide external inspection. An extremely capable attacker may choose to directly subvert the underlying VMM. First, the virtualization overheads, including relative differences in the amount of time needed to complete certain I/O operations or virtualized instructions (as compared to a non-virtualized hardware interface), provide “hints” to infer the existence of a VMM. Second, based on the detected VMM interface, “proper” design and implementation flaws may be discovered in the VMM code that allows the subversion attacks. However, it is currently unclear to what extent such attacks would succeed. It should be noted that the VMM code base is relatively smaller and more stable than the legacy OS code. This current assumption may be considered reasonable for the time being. Furthermore, precaution counter-measures can also be taken to mitigate this threat by defensively screening the VMM code and thoroughly analyzing them to reduce and hopefully eliminate these flaws.

D. VM Fingerprinting

The virtualization environment can potentially be fingerprinted and detected [23, 60] by attackers. In fact, a number of recent malware systems are able to check whether they are running inside a VM, and if so, choose to inhibit different behavior [30]. As a counter-measure, the fidelity of VM implementation (e.g., as proposed in [61, 62]) can be improved to thwart some of the VM detection schemes. Meanwhile, from another perspective, perspective, as virtualization continues to gain popularity, the concern over VM detection may become less significant because most malware would become VMM-agnostic once again as VMs could be attractive targets for attackers as well.

### V. RELATED WORK

Current embodiments of VMwatcher are related to three areas of prior work: enhancing security with virtual machines, implementing malware with virtual machines, and detecting system integrity violations with independent secure monitors.

Leveraging recent advances in virtual machine technologies, researchers have used virtual machines to detect intrusions [7, 10, 16], analyze intrusions [6, 15], diagnose system problems [13, 26, 27], isolate services [4, 17], and implement honeypots [50, 1, 9]. These services leverage the desirable properties (e.g., encapsulation, isolation, and compatibility) provided by virtual machines to enhance the security of systems without relying on the correctness of the guest OS and other application-level programs. Livewire [7] applies virtual machine introspection to detect intrusions.

Besides the design difference in using non-intrusive VMI, the current embodiments differ from these works in three other ways. First, current embodiments use a new guest function extrapolation technique to derive semantic-rich internal information (e.g., files, processes, and kernel modules) that cannot be directly obtained via virtual machine introspection. Second, current embodiments use another key technique (i.e., transparent representation) that allows the direct support of off-the-shelf anti-virus software, while Garfinkel and Rosenblum only supports a specialized IDS that is built from scratch to detect possible intrusions. Third, current embodiments apply the idea of cross-view differential analysis and obtain an internal and external view on a system to detect the most stealth malware, whereas Garfinkel and Rosenblum mainly examines the VM states from an external system view.

IntroVirt [10] is another closely related work that applies the same technique to execute custom vulnerability-specific predicates in a VM for intrusion detection. There are two major differences between IntroVirt and embodiments of VMwatcher. First, IntroVirt develops a specialized predicate engine that does not accommodate commodity anti-virus software that are being supported by VMwatcher. Second, IntroVirt needs to overwrite a portion of vulnerable program code with its own predicates or invoke existing code in either guest applications or the guest kernel. Such an approach may be considered as intrusive and may inevitably introduce undesirable perturbations on the target system. Some of them may even lead to elusive race conditions in the guest OS that are hard to detect. Consequently, it must resort to taking a checkpoint of the whole virtual machine before making any changes to the target VM state and then rolling back to the saved checkpoint after the predicate execution [10]. In contrast, embodiments of VMwatcher utilize a non-intrusive approach and are able to readily support a wide variety of anti-virus software.

Also leveraging the very same techniques, researchers have demonstrated possible threats in implementing stealth malware based on virtualization [14, 23, 28]. For instance, Sam King et al. [14] proposes the notion of virtual machine-based rootkit (VMBR) that can be dynamically inserted underneath an existing operating system. Joanna Rutkowska [23] further implemented a hardware virtualization-based rootkit prototype called “Blue Pill”, claiming the creation of 100% undetectable malware. Dino Dai Zovi [28] independently implemented another hardware virtualization-based rootkit called “Vitriol”, confirming this significant threat.

These threats exactly reflect the “dark” side of the double-sided sword brought by advanced technologies such as virtual machines. In contrast, embodiments of VMwatcher have an opposite goal: to strive to detect stealth malware that may be deeply planted inside a VM. These threats can be defeated by recent research efforts on secure booting [2], as well as secure hypervisors, such as sHype [24] and TRANGO [52]. Based on secure booting, these secure hypervisors aim to securely maintain the lowest-level access on the system, and prevent them from being subverted. VMwatcher can be naturally combined with them to achieve better protection.

The third area of related research involves projects that enable the detection of system integrity violation by independent secure monitors [20, 21, 22]. Copilot [21] detects possible kernel integrity violation by running the monitor software entirely on its own PCI add-in card. As such, it does not rely on the correctness of the host that it is monitoring and is resistant to tampering from the host. The follow-up work [20] advances the violation detection through a specification-based semantic integrity checker on dynamic kernel data. It should be noted that these two systems only take snapshots of volatile states (i.e., physical memory). Storage-based intrusion monitor [22] leverages the isolation provided by a file server (e.g., a NFS server) and independently detects possible symptoms of malware infections. Generally, it only captures a system's persistent states while sacrificing the visibility on its running volatile states. In contrast, VMwatcher examines both volatile states (e.g., physical memory) and persistent states (e.g., the virtual disk) to detect malware infections.

Finally, an embodiment of VMwatcher is compared with other general intrusion detection systems, in particular host-based IDSes [38, 40, 46, 12] and network-based IDSes [43, 19]. Network-based IDSes are deployed outside of a system, allowing them to achieve high attack resistance but at the cost of reducing the visibility on the internal system states. Host-based IDSes running inside the system may be able to directly inspect the state of monitored systems, thus providing better visibility. Simultaneously however, they sacrifice attack resistance as they could be potentially compromised by attackers after break-ins. In contrast, VMwatcher may offer high attack resistance by the external execution of anti-virus software while still maintaining high visibility on the internal semantic-rich system states.

### VI. CONCLUSION

Embodiments of a VMwatcher, a novel virtual machine-based system that is configured to run commodity anti-virus software outside of a VM while still detecting internal malware infections is disclosed. Embodiments of VMwatcher include three virtualization-based techniques: (1) virtual machine introspection, (2) guest function extrapolation, and (3) transparent representation. These techniques successfully export internal semantic-rich information to external anti-virus processes. Evaluations in both Linux and Windows platforms have demonstrated its practicality and effectiveness. Moreover, the experiments with advanced stealth malware demonstrate its unique capability in detecting these sophisticated malware.

### VII. REFERENCES

The following references are referred to as an aid to explain and enable the present embodiments. In several instances, the references have been referenced by their preceding number references.
[1] K. G. Anagnostakis, S. Sidiroglou, P. Akritidis, K. Xinidis, E. Markatos, and A. D. Keromytis. Detecting Targeted Attacks Using Shadow Honeypots. Proc. of the 14th USENIX Security Symposium, August 2005.
[2] William A. Arbaugh, David J. Farbert, and Jonathan M. Smith. A Secure and Reliable Bootstrap Architecture. Proc. of the 1997 IEEE Symposium on Security and Privacy, 1997.
[3] P. Barham, B. Dragovic, K. Fraser, S. Hand, T. Harris, R. Neugebauer A. Ho, I. Pratt, and A. Warfield. Xen and the Art of Virtualization. Proc. of the 19th ACM Symposium on Operating Systems Principles, October 2003.
[4] Eric Bryant, James Early, Rajeev Gopalakrishna, Gregory Roth, Eugene H. Spafford, Keith Watson, Paul Williams, and Scott Yost. Poly2 Paradigm: A Secure Network Service Architecture. Proc. of the 19th Annual Computer Security Applications Conference, December 2003.
[5] J. Dike. User Mode Linux. http://user-mode-linux.sourceforge.net.
[6] George W. Dunlap, Samuel T. King, Sukru Cinar, Murtaza A. Basrai, and Peter M. Chen. ReVirt: Enabling Intrusion Analysis Through Virtual-Machine Logging and Replay. 5th Symposium on Operating Systems Design and Implementation (OSDI), December 2002.
[7] T. Garfinkel and M. Rosenblum. A Virtual Machine Introspection Based Architecture for Intrusion Detection. Proc. of the 2003 Network and Distributed System Security Symposium, February 2003.
[8] Tal Garfinkel, Ben Pfaff, Jim Chow, Mendel Rosenblum, and Dan Boneh. Terra: A Virtual Machine-Based Platform for Trusted Computing. Proc. of the 2003 Symposium on Operating Systems Principles (SOSP), October 2003.
[9] X. Jiang and D. Xu. Collapsar: A VM-Based Architecture for Network Attack Detention Center. Proc. of the 13th USENIX Security Symposium, August 2004.
[10] Ashlesha Joshi, Samuel T. King, George W. Dunlap, and Peter M. Chen. Detecting Past and Present Intrusions through Vulnerability-specific Predicates. Proc. of the 2005 Symposium on Operating Systems Principles (SOSP), October 2005.
[11] Kdm. Win32 Portable Userland Rootkit. Ph rack 62:article 12 of 16, July 2004.
[12] Gene H. Kim and Eugene H. Spafford. Experiences with Tripwire: Using Integrity Checkers for Intrusion Detection. In Systems Administration, Networking and Security Conference III, USENIX, 1994.
[13] S. T. King, George W. Dunlap, and P. M. Chen. Debugging Operating Systems with Time-Traveling Virtual Machines. Proc. of the 2005 Annual USENIX Technical Conference, April 2005.
[14] Samuel T. King, Peter M. Chen, Yi-Min Wang, Chad Verbowski, Helen J. Wang, and Jacob R. Lorch. SubVirt: Implementing Malware with Virtual Machines. Proc. of the 2006 IEEE Symposium on Security and Privacy, 2006.
[15] Toshihiko Koju, Shingo Takada, and Norihisa Doi. An Efficient and Generic Reversible Debugger using the Virtual Machine based Approach. Proc. of the 1st ACM/USENIX International Conference on Virtual Execution Environments, June 2005.
[16] Kenichi Kourai and Shigeru Chiba. HyperSpector: Virtual Distributed Monitoring Environments for Secure Intrusion Detection. Proc. of the 1st ACM/USENIX International Conference on Virtual Execution Environments, June 2005.
[17] R. Meushaw and D. Simard. NetTop: Commercial Technology in High Assurance Applications. Tech Trend Notes: Preview of Tomorrow's Information Technologies, September 2000.
[18] Jason V. Miller. SHV4 Rootkit Analysis. SHV4Rootkit. pdj, October 2003.
[19] V. Paxson. Bro: A System for Detecting Network Intruders in Real-Time. Computer Networks, 31(23-24):2345-2463, 1999.
[20] N. Petroni, T. Fraser, A. Walters, and W. Arbaugh. An Architecture for Specification-Based Detection of Semantic Integrity Violations in Kernel Dynamic Data. Proc. of the 15th USENIX Security Symposium, August 2006. https://tms.symantec.com/members/AnalystReports/030929-Analysis-
[21] N. L. Petroni, T. Fraser, J. Molina, and W. A. Arbaugh. Copilot—a Coprocessor-based Kernel Runtime Integrity Monitor. Proc. of the 13th USENIX Security Symposium, August 2004.
[22] Adam G. Pennington, John D. Strunk, John Linwood Griffin, Craig A. N. Soules, Garth R. Goodson, and Gregory R. Ganger. Storage-based Intrusion Detection: Watching Storage Activity for Suspicious Behavior. Proc. of the 12th USENIX Security Symposium, August 2003.
[23] Joanna Rutkowska. Subverting Vista Kernel for Fun and Profit. Blackhat 2006, August 2006.
[24] R. Sailer, E. Valdez, T. Jaeger, R. Perez, L. van Doom, J. L. Griffin, and S. Berger. sHype: Secure Hypervisor Approach to Trusted Virtualized Systems. IBM Research Report RC235I I, February 2005.
[25] Yi-Min Wang, Doug Beck, Binh Vo, Roussi Roussev, and Chad Verbowski. Detecting Stealth Software with Strider GhostBuster. Proc. of the 2005 International Conference on Dependable Systems and Networks, June 2005.
[26] A. Whitaker, Richard S. Cox, and S. D. Gribble. Configuration Debugging as Search: Finding the Needle in the Haystack. Proc. of USENIX OSDI2004, December 2004.
[27] Andrew Whitaker, Richard S. Cox, and Steven D. Gribble. Using Time Travel to Diagnose Computer Problems. Proc. of the 11th SIGOPS European Workshop, September 2004.
[28] Dino Dai Zovi. Hardware Virtualization Based Rootkits. Blackhat 2006, August 2006.
[29] AFX Rootkit. http://www.rootkit.comlproject.php?id=23.
[30] Agobot. http://www.f-secure.comlv-descs/agobot.shtml.
[31] Clam AntiVirus. http://www.clamav.netl.
[32] eWeek Security News: Anti-Virus Software Is Ineffective. http://www.eweek.comiarticle2/0.I895.2040760.00.asp.
[33] FU Rootkit. http://www.rootkit.comlproject.php ?id=12.
[34] FUTo Rootkit. http://www.rootkit.comiproject.php?id=31.
[35] HE4Hook Rootkit. http://www.rootkit.comlproject.php ?id=6.
[36] hxdef. http://hxdef.czweb.org.
[37] Linux Adore Worms. http://securityresponse.symantec.comlavcenter/venc/data/linux.adore.worm.html.
[38] McAfee VirusScan. http://www.mcafee.comlus/enterprise/products/anti_virusl.
[39] Microsoft Security Bulletin MS05-055: Vulnerability in Windows Kernel Could Allow Elevation of Privilege.
http://www.microsoft.comltechnet/security/BulletinIMS05-055.mspx.
[40] Microsoft Windows Defender. http://www.microsoft.comlathome/security/spyware/software/default.mspx.
[41] NTRootkit. http://www.megasecurity.org/Tools/Nt]ootkit . . . all.html.
[42] Rbot. http://research.sunbelt-software.comlthreatdisplay.aspx?name=Rbot&threatid=I 4953.
[43] Snort. http://www.snort.org.
[44] Software Complexity. http://en.wikipedia.org/wikiiSourceJines . . . Df . . . code.
[45] Sophos Anti-Virus. http://www.sophos.comlproducts/es/endpointl.
[46] Symantec AntiVirus. http://www.symantec.com/homeJIOmeoffice/products/overview.jsp?pcid=is&pvid=nav2007.
[47] The adore-ng Rootkit. http://stealth.openwall.net/rootkits/.
[48] The adore Rootkit. http://lwn.net/Articles/75990/.
[49] The Chrootkit Tool. http://www.chkrootkit.orgl.
[50] The Honeynet Project. http://www.honeynet.org.
[51] The Strange Decline of Computer Worms. http://www.theregister.co.uk/2005/03/I7If-secure_websec/print.html.
[52] TRANGO, the Real-Time Embedded Hypervisor. http://www.trango-systems.coml.
[53] Vanquish Rootkit. http://www.rootkit.comlproject.php?id=9.
[54] Virus Writers Get Stealthy. http://news.zdnet.co.uk/internet/security/0,39020375,39I9I840,00.htm.
[55] VMware. http://www.vmware.coml.
[56] Volume Shadow Copy Service. http://technet2.microsoft.comIWindowsServer/enllibrary/2bOd2457-b7d8-42c3-b6c9-59cI45b7765fI033.mspx?mfr=true.
[57] Wikipedia: File Locking. http://en.wikipedia.org/wiki/FileJocking.
[58] CERT Advisory CA-2002-17 Apache Web Server Chunk Handling Vulnerability. http://www.cert.org/advisories/CA-200217.html, March 2003.
[59] Linux Kernel Ptrace Privilege Escalation Vulnerability. http://www.secunia.comladvisories/8337/. March 2003.
[60] T. Klein. Scooby Doo—VMware Fingerprint Suite. http://www.trapkit.de/research/vmm/scoobydoo/index.html, 2003.
[61] K. Kortchinsky. Honeypots: Counter measures to VMware fingerprinting. http://seclists.org/lists/honeypots/2004/Jan-Mar/0015.html, January 2004.
[62] T. Liston and E. Skoudis. On the Cutting Edge: Thwarting Virtual Machine Detection. http://handlers.sans.org/tliston/ThwartingVMDetection_Liston_Skoudis.pdf, 2006.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL), such as VHSIC hardware description language (VHDL) or Verilog, that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of embedding a block authentication code in a data stream for authentication purposes. However, one skilled in the art will recognize that embodiments of the invention could be used to embed other types of information in the data blocks such as hidden keys or messages. One of many ways that this could be accomplished is by using a specific hash function that results in a value that either directly or in combination with other data can result in one learning this other type of information.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer readable medium, the computer readable medium including a series of computer readable instructions that when executed by one or more processors performs a method for detecting malware on a virtual machine, the virtual machine residing on a host operating system, the instructions executed from outside the virtual machine, the method comprising:
a. retrieving for inspection virtual machine internal system states from virtual resources, based on non-intrusive virtual machine introspection without perturbing their execution, the virtual resources including:
i. virtual machine memory; and
ii. at least one virtual disk; and
the virtual machine internal system states comprising:
i. virtual memory states; and
ii. virtual disk states;
b. extrapolating guest functions by interpreting the virtual memory states and the virtual disk states; and
c. transparently encapsulating and presenting the interpreted virtual memory states and the interpreted virtual disk states to anti-malware software; and
wherein the anti-malware software is configured to use the interpreted virtual memory states and the interpreted virtual disk states to detect system compromises.

2. The computer readable medium according to claim 1, wherein at least some of the instructions are executed on the host operating system.

3. The computer readable medium according to claim 1, wherein the instructions further include retrieving virtual network interface states from at least one virtual network interface.

4. The computer readable medium according to claim 1, further including retrieving for inspection virtual machine internal system events from the virtual resources, based on non-intrusive virtual machine introspection without perturbing their execution, the virtual machine internal system events comprising:
a. virtual memory events; and
b. virtual disk events.

5. The computer readable medium according to claim 4, wherein the virtual machine internal system events are retrieved using instructions executed between the host operating system and the virtual machine.

6. The computer readable medium according to claim 4, further including interpreting the virtual memory events.

7. The computer readable medium according to claim 6, further including transparently encapsulating and presenting the interpreted virtual memory events to the anti-malware software, the anti-malware software further configured to use the virtual memory events to detect system compromises.

8. The computer readable medium according to claim 4, further including interpreting the virtual disk events.

9. The computer readable medium according to claim 8, further including transparently encapsulating and presenting the interpreted virtual disk events to the anti-malware software, the anti-malware software configured to use the virtual disk events to detect system compromises.

10. A malware detection system, comprising:
a. a guest operating system running on a virtual machine, the virtual machine residing on a host operating system, the virtual machine having virtual resources, the virtual resources including:
i. virtual machine memory; and
ii. at least one virtual disk; and
b. a virtual machine examiner residing outside the virtual machine, the virtual machine examiner including:
i. a virtual machine inspector, the virtual machine inspector configured to retrieve for inspection virtual machine internal system states from the virtual resources, based on non-intrusive virtual machine introspection without perturbing their execution, the virtual machine internal system states comprising:
1. virtual memory states; and
virtual disk states;
ii. a guest function extrapolator, the guest function extrapolator configured to extrapolate guest functions by:
1. interpreting the virtual memory states; and
2. interpreting the virtual disk states; and
iii. a transparent presenter, the transparent presentor configured to encapsulate and present the interpreted virtual memory states and the interpreted virtual disk states to anti-malware software, the anti-malware software configured to use the interpreted virtual memory states and the interpreted disk states to detect system compromises.

11. The malware detection system according to claim 10, wherein the virtual machine examiner runs on the host operating system.

12. The malware detection system according to claim 10, wherein the virtual resources further include at least one virtual network interface.

13. The malware detection system according to claim 12, wherein the virtual machine inspector is further configured to retrieve virtual network interface states from the at least one virtual network interface.

14. The malware detection system according to claim 10, wherein the virtual machine inspector is further configured to retrieve for inspection virtual machine internal system events from the virtual resources, based on non-intrusive virtual machine introspection without perturbing their execution, the virtual machine internal system events comprising:
i. virtual memory events; and
ii. virtual disk events;

15. The malware detection system according to claim 14, wherein
a. the virtual machine inspector retrieves the virtual memory events from a virtual machine monitor;
b. the virtual machine monitor runs between the host operating system and the virtual machine; and
c. the virtual machine monitor is configured to intercept the virtual memory events.

16. The malware detection system according to claim 15, wherein the guest function extrapolator is further configured to interpret the virtual memory events.

17. The malware detection system according to claim 16, wherein
a. the transparent presentor is further configured to encapsulate and present the interpreted virtual memory events to anti-malware software; and
b. the anti-malware software is further configured to use the virtual memory events to detect system compromises.

18. The malware detection system according to claim 14, wherein:
a. the virtual machine inspector retrieves the virtual disk events from a virtual machine monitor;
b. the virtual machine monitor runs between the host operating system and the virtual machine; and
c. the virtual machine monitor is configured to intercept the virtual disk events.

19. The malware detection system according to claim 18, wherein the guest function extrapolator is further configured to interpret the virtual disk events.

20. The malware detection system according to claim 19, wherein
a. the transparent presentor is further configured to encapsulate and present the interpreted virtual disk events to anti-malware software; and
b. the anti-malware software is configured to use the virtual disk events to detect system compromises.
